(19) United States
(12) Patent Application Publication
(10) Pub. No.: US 2017/0127128 A1
(43) Pub. Date: May 4, 2017

(54) Social Post Roll Up and Management System and Method of Use

(71) Applicant: Stephen Vollentine Seger, Houston, TX (US)

(72) Inventor: Stephen Vollentine Seger, Houston, TX (US)

(21) Appl. No.: 15/341,989

(22) Filed: Nov. 2, 2016

Related U.S. Application Data
(60) Provisional application No. 62/249,759, filed on Nov. 2, 2015.

(51) Int. Cl. H04N 21/442; H04L 29/08; H04N 21/4788; G06F 17/30

(52) U.S. Cl. CPC H04N 21/44213; G06F 17/30339; H04L 67/22; H04N 21/4788; G06Q 50/01

(57) ABSTRACT

A software system is disclosed. A one or more computers comprises a processor, a memory and a communication hardware. Said memory comprises said software system. Said software system comprises a device application and a database tables. Said database tables comprises a one or more tracked activities or interactions, a one or more assets, a one or more stories, a one or more flicks and a one or more curated setting files are configured to track a list of users, a list of assets, a list of composite assets, and a list of curated settings files. Said database tables are configured to track a list of users. Said software system comprises a raw asset layer, a composite asset layer and a curated asset layer. Said raw asset layer comprises said one or more tracked activities or interactions and said one or more assets.

### CROSS-REFERENCE TO RELATED APPLICATIONS

This application claims benefit to US Patent Application No. 62/249,759 filed on Nov. 2, 2015.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

Examples of prior art can be found in US Patent Application Number(s): US 20140172427 A1, US 20150081713 A1, U.S. Pat. No. 8,914,483 B1, and US 20120213404 A1.

None of the known inventions and patents, taken either singularly or in combination, is seen to describe the instant disclosure as claimed.

### BRIEF SUMMARY OF THE INVENTION

A software system is disclosed. A one or more computers comprises a processor, a memory and a communication hardware. Said memory comprises said software system. Said software system comprises a device application and a database tables. Said database tables comprises a one or more tracked activities or interactions, a one or more assets, a one or more stories, a one or more flicks and a one or more curated setting files are configured to track a list of users, a list of assets, a list of composite assets, and a list of curated settings files. Said database tables are configured to track a list of users. Said software system comprises a raw asset layer, a composite asset layer and a curated asset layer. Said raw asset layer comprises said one or more tracked activities or interactions and said one or more assets. Said composite asset layer comprises said one or more stories and said one or more flicks. Said curated asset layer comprises said one or more curated setting files. Said one or more tracked activities or interactions comprise a list of activities of a one or more users being tracked in said list of users in said database tables. Said one or more assets comprise a plurality of digital asssets selected among a one or more images, a one or more videos, a one or more virtual reality files, or a one or more augmented reality files. Said one or more stories comprise a portion of said one or more raw asset layer being packaged up together. Said one or more flicks comprise a portion of said one or more raw asset layer being packaged up together. Said one or more curated setting files a portion of said composite asset layer being selected and combined to create a curated composite asset having economic value to at least one end user. A channels comprise collections of said raw asset layer, said composite asset layer, and said curated asset layer being grouped together on a similar theme and shared to a portion of said one or more users of said software system.

A software system is disclosed. A one or more computers comprises a processor, a memory and a communication hardware. Said memory comprises said software system. Said software system comprises a device application and a database tables. Said database tables comprises a one or more tracked activities or interactions, a one or more assets, a one or more stories, a one or more flicks and a one or more curated setting files. Said database tables are configured to track a list of users. Said software system comprises a raw asset layer, a composite asset layer and a curated asset layer. Said curated asset layer comprises said one or more curated setting files.

A software system is disclosed. A one or more computers comprises a processor, a memory and a communication hardware. Said memory comprises said software system. Said software system comprises a device application and a database tables. Said software system comprises a raw asset layer and a composite asset layer. Said database tables are configured to track a list of users. Said composite asset layer comprises a one or more fresh assets. Said one or more fresh assets comprise a creation date being less than a threshold period from the current date.

A software system use method is disclosed. Said software system use method comprises a collecting composite assets step, a creating a curated setting files step and a preserving said curated setting files step. Said software system use method comprises a software system, a one or more computers and a network. Said one or more computers comprises a one or more input devices, an address space, a processor, a memory, a communication hardware and a device application. Said software system processes said software system use method. Said software system comprises a raw asset layer and a composite asset layer. Said collecting composite assets step identifying a portion of said composite asset layer based on location or user authority. Said raw asset layer comprises a one or more tracked activities or interactions and a one or more assets. Said composite asset layer a one or more from among said raw asset layer. A curated asset layer a one or more from among said composite asset layer. Said creating a curated setting files step combining a one or more from among said composite asset layer into a one or more one or more curated setting files. Said preserving said curated setting files step comprises saving said one or more curated setting files according to a settings.

### BRIEF DESCRIPTION OF THE SEVERAL VIEWS OF THE DRAWING

FIG. 1 illustrates a flow chart view of a first network configuration 100.

FIG. 2A illustrates a perspective overview view of a mobile phone 201a.

FIG. 2B illustrates a perspective overview view of a personal computer 201b.

FIG. 2C illustrates a perspective overview view of a tablet 201c.

FIG. 3A illustrates block diagram view of an address space 302a.

FIG. 3B illustrates block diagram view of a first computer 102a.

FIG. 3C illustrates block diagram view of a server 108.

FIG. 4A illustrates a flow chart view of a one or more computers 102.

FIG. 4B illustrates block diagram view of a first computer 102a.

FIG. 5A illustrates memory space view of a one or more computers 102.

FIG. 5B illustrates block diagram view of a memory 306a.

FIG. 6 illustrates a flow chart view of a navigation diagram 600.

FIG. 7 illustrates a flow chart view of a database tables 700.

FIG. 8 illustrates an elevated overview view of a welcome screen 800.

FIG. 9 illustrates a flow chart view of an asset capture process 900.

FIG. 10 illustrates GUI view of a new asset dialog 1002.

FIG. 11A illustrates an elevated overview view of a layered asset 1100.

FIG. 11B illustrates an elevated overview view of a layered asset 1100.

FIG. 11C illustrates an elevated overview view of a layered asset 1100.

FIG. 11D illustrates an elevated overview view of a layered asset 1100.

FIG. 12 illustrates a perspective overview view of an AR goggles demonstration 1200.

FIG. 13 illustrates an elevated overview view of a map dialog screen 1300.

FIG. 14 illustrates an elevated overview view of a current flicks screen 1400.

FIG. 15 illustrates an elevated overview view of a flick editing screen 1502.

FIG. 16 illustrates an elevated overview view of a composite asset screen 1602.

FIG. 17 illustrates an elevated overview view of a my flicks screen 1702.

FIG. 18 illustrates an elevated overview view of a composite asset screen 1802.

FIG. 19 illustrates a flow chart view of a categorizations hierarchy 1900.

FIG. 20 illustrates a flow chart view of a badge creation process 2000.

FIG. 21 illustrates an elevated overview view of a channels screen 2100.

FIG. 22 illustrates an elevated overview view of a channel view screen 2202.

FIG. 23 illustrates an elevated overview view of a flick playback screen 2302.

FIG. 24 illustrates an elevated overview view of a top flicks screen 2400.

FIG. 25 illustrates an elevated overview view of an user profile screen 2502.

FIG. 26 illustrates an elevated overview view of an alerts screen 2602.

FIG. 27 illustrates an elevated overview view of an user feed screen 2700.

FIG. 28 illustrates an elevated overview view of a friends screen 2800.

FIG. 29 illustrates an elevated overview view of a menu screen 2902.

FIG. 30 illustrates GUI view of an user profile and system data screen 3000.

FIG. 31 illustrates a GUI view of an user's assets tab 3004.

FIG. 32 illustrates a GUI view of an user's flicks tab 3006.

FIG. 33 illustrates a GUI view of an user's activities tab 3008.

FIG. 34 illustrates a GUI view of a new asset dialog 3402.

FIG. 35 illustrates a GUI view of an add new flick screen 3502.

FIG. 36 illustrates a GUI view of a created badges tab 3014.

FIG. 37 illustrates a GUI view of a created badges tab 3016.

FIG. 38 illustrates a GUI view of a create channel tab 3018.

FIG. 39 illustrates data table view of a tblUsers 702.

FIG. 40 illustrates data table view of a tblAssets 704.

FIG. 41 illustrates data table view of a tblFlicks 706.

FIG. 42 illustrates data table view of a tblCRTAssetsInFlicks 708.

FIG. 43 illustrates data table view of a tbleBadges 710.

FIG. 44 illustrates data table view of a tblCRTBadgesEarneds 712.

FIG. 45 illustrates data table view of a tblmerits 714.

FIG. 46 illustrates data table view of a tblCRTmeritEarneds 716.

FIG. 47 illustrates data table view of a tblCRTmeritsInBadges 718.

FIG. 48 illustrates data table view of a tblUserActivities 720.

FIG. 49 illustrates data table view of a tblCRTActivitiesInmerits 722.

FIG. 50 illustrates data table view of a tblAllActivities 724.

FIG. 51 illustrates data table view of a tblChannels 726.

FIG. 52 illustrates data table view of a tblCRTUserConnections 728.

FIG. 53 illustrates data table view of a tblFeedback 730.

FIG. 54 illustrates a flow chart view of a software system use method 5402.

FIG. 55 illustrates a flow chart view of an asset progression chart 5500.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

These parts are illustrated in the figures and discussed below: a first network configuration 100, a software system 101, a one or more computers 102, a first computer 102a, a second computer 102b, a third computer 102c, a one or more locations 103, a first location 103a, a second location 103b, a third location 103c, a printer 104, a network 106, a server 108, a data storage 110, a data storage 110a, a mobile phone 201a, a personal computer 201b, a tablet 201c, a screen 202, a one or more input devices 204, a keyboard 204a, a trackball 204b, a one or more cameras 204c, a track pad 204d, a data 206, a home button 220, an address space 302, an address space 302a, an address space 302b, an address space 302c, an address space 302d, a processor 304, a processor 304a, a processor 304b, a processor 304c, a processor 304d, a memory 306, a memory 306a, a memory 306b, a memory 306c, a memory 306d, a communication hardware 308, a communication hardware 308a, a communication hardware 308b, a communication hardware 308c, a communication hardware 308d, a device application 502, a data records 504a, a data records 504b, a data records 504c, a data records 504d, a server application 506, a navigation diagram 600, a welcome screen 602, a my feed 604, a capture asset 606, an AR goggles 608, a geo-messages 610, a create geo-message 610a, a read geo-messages 610b, a current flicks 612, an active flicks 612a, a real-time flicks 612b, a recent flicks here 612c, a badges 614, an available badges 614a, a badges here 614b, a channels 616, a create flick 618, a top flicks 620, a tag flick 620a, a react to flick 620b, a my profile 622, a my flicks 622a, a my badges 622b, a review old flicks 622c, a my channels 622d, a friends 624, a my friends flicks 624a, a database tables 700, a tblUsers 702, an ID 702a, an userInfo 702b, an userName 702c, a tblAssets 704, an ID 704a, a refOwner 704b, an assetInfo 704c, a dateCreated 704d, a locationInfo 704e, a share 704f, a tblFlicks 706, an ID 706a, a flickInfo 706b, a refOwner 706c, a dateFlick 706d, a share 706f, a tblCRTAssetsInFlicks 708, an ID 708a, a refFlick 708b, a refAssets 708c, a tbleBadges 710, an ID 710a, a refOwner 710b, a BadgeInfo 710c, a tblCRTBadgesEarneds 712, an ID 712a, a refOwner 712b, a refBadge 712c, a dateEarned 712d, a tblmerits 714, an ID 714a, a refOwner 714b, a meritName 714c, a requirements 714d, a tblCRTmeritEarneds 716, an ID 716a, a refOwner 716b, a refmerit 716c, a dateEarned 716d, a tblCRTmeritsInBadges 718, an ID 718a, a refBadge 718b, a refmerit 718c, a quantity 718d, a refOwner 718e, a tblUserActivities 720, an ID 720a, an activityDate 720b, a locationInfo 720c, an activityDetails 720d, a refActivity 720e, a tblCRTActivitiesInmerits 722, an ID 722a, a refOwner 722b, a refOwner 722c, a refAllActivities 722d, a quantity 722e, a tblAllActivities 724, an ID 724a, an activityName 724b, an activityLocation 724c, an expires 724d, a startDate 724e, an endDate 724f, a refOwner 724g, a costPerUser 724h, a purchaseInfo 724k, a tblChannels 726, an ID 726a, an owner 726b, a channelName 726c, a category 726d, a geoInfo 726e, an expires 726f, a startDate 726g, an endDate 726h, a hubChannel 726k, a tblCRTUserConnections 728, an ID 728a, a refUserFirst 728b, a refUserSecond 728c, a receiveNotifications 728d, a tblFeedback 730, an ID 730a, a refUser 730b, a refactivity 730c, a refFlick 730d, a refAsset 730e, a refBadge 730f, a refMerit 730g, a date 730h, a feedbackText 730k, a rank 730m, an approveFlag 730n, a welcome screen 800, a one or more display windows 802, a happening now flicks window 802a, a top flicks window 802b, a friends flicks window 802c, an upcoming flicks window 802d, a one or more real time flicks 804, a first flick 804a, an earn second badge flick 804b, a VR-in link 806a, a navigate link 808a, an info link 810a, a one or more top flicks 812, a first top flick 812a, a second top flick 812b, a Best of Island Party 2017 flick 812c, a one or more friends flicks 814, a first friends flick 814a, a second friends flick 814b, a one or more upcoming flicks 816, a first upcoming flick 816a, a second upcoming flick 816b, a happy hour upcoming flick 816c, a menu button 820, a capture button 822, a home button 824, an user info indicator 826, a navigation bar 828, a my feeds button 828a, an AR goggles button 828b, a badges button 828c, a channels button 828d, a create flick button 828e, a my profile button 828f, a friends button 828g, a messaging button 830, an asset capture process 900, a press capture button step 902, a create an asset step 904a, a link to remote asset step 904b, an add virtual object option 906, an add to channel option 908, an add to flick option 910, a new asset dialog 1002, a cancel button 1004, a retake button 1006, an asset options 1008, an add as story button 1010, an add to horizon button 1012, an add to camera roll 1014, an add to my flick zone 1016, an add to first flick 1016a, an add to second flick 1016b, a create new flick 1018, a make private 1020, a new asset 1022, an add virtual object 1024, a link to external asset 1026, a layered asset 1100, a one or more layers 1102, a visible layer 1102a, a cutout layer 1102b, a virtual object layer 1102c, an AR goggles demonstration 1200, an AR software screen 1202, a photograph subject 1204, a real world image portions 1206, a virtual object portion 1208, a map dialog screen 1300, a map graphic 1302, a current location 1304, a message location 1306, a current flicks screen 1400, a one or more flicks 1402, a first flick 1402a, a second flick 1402b, a third flick 1402c, a fourth flick 1402d, a flick editing screen 1502, a flick users 1504, a one or more flick users 1506, a first user 1506a, a second user 1506b, a third user 1506c, a forth user 1506d, a tagged hub zone 1508, a hub name 1510a, an add to my library button 1512, a banner image 1514, a flick name field 1516, a publish button 1518, a location summary zone 1520, a region setting 1520a, a state setting 1520b, a county setting 1520c, a create-edit button 1522, a preview flick 1524, a composite asset screen 1602, an available assets zone 1604, a create collage zone 1606, a create film zone 1608, a one or more assets 1610, a collage 1612, a cancel button 1614, a submit button 1616, a video timeline 1618, a my flicks screen 1702, a flicks in progress zone 1704, a previous flicks zone 1706, a one or more flicks 1708, a first flick 1708a, a previous flick 1708b, an edit button 1710, a close flick button 1712, an add new flick button 1714, a time remaining indicator 1720, a composite asset screen 1802, an available assets zone 1804, a create collage zone 1806, a create film zone 1808, a one or more fresh assets 1810, a collage 1812, a cancel button 1814, a submit button 1816, a categorizations hierarchy 1900, a one or more tracked activities or interactions 1902, a beach day activity 1902a, a beach day activity 1902b, a hole-in-one activity 1902c, a one or more merit achievements 1904, a top flick 1904a, a pub crawler 1904b, a hole-in-one miniature golf 1904c, a tournament winner miniature golf 1904d, a ten days at the beach 1904e, a one or more badge achievements 1906, an ace miniature golfer 1906a, a beach bum 1906b, a badge creation process 2000, a start point 2002a, an end point 2002b, a first step 2004a, a second step 2004b, a third step 2004c, a fourth step 2004d, a fifth step 2004e, a sixth step 2004f, a seventh step 2004g, a channels screen 2100, an users channel zone 2102, a first channel 2102a, a second channel 2102b, a third channel 2102c, a fourth channel 2102d, a suggested channels zone 2104, a first channel 2104a, a second channel 2104b, an activate notifications 2106a, an activate notifications 2106b, an activate notifications 2106c, a deactivate notifications 2106d, a hub name 2108a, a hub name 2108b, a hub name 2108c, a hub name 2108d, a hub name 2110a, a hub name 2110b, a follow button 2112a, a follow button 2112b, a channels search area 2120, a search query 2122, a channel view screen 2202, a current channel title 2204, a top post zone 2206, a flick post 2208, a verified media files feed zone 2210, a transfer box zone 2212, a horizon image 2214, a subscribe button 2216, a subscribers button 2218, a flick playback screen 2302, a flick assets 2304, a first image 2304a, a first video 2304b, a flick name field 2308, a play button 2310, a delete button 2312, a flag button 2314, a make public 2316, a back button 2320, a view in VR button 2322, a top flicks screen 2400, an user profile screen 2502, an user library zone 2504, a first library 2504a, a second library 2504b, a third library 2504c, an user information zone 2506, a favorite hub 2506a, a name 2506b, a birthday 2506c, a bio 2506d, a friend count 2506e, a channel count 2506f, an user badge zone 2508, a first badge 2508a, a second badge 2508b, a horizon image 2510, a profile image 2512, a cancel button 2514, a submit button 2516, an alerts screen 2602, an alerts zone 2604, a friend request 2604a, a video share notification 2604b, a video rank notification 2604c, a group flick post 2604d, a badge accrual 2604e, a status update 2604f, an accept button 2606a, an accept button 2606d, a cancel button 2608a, a cancel button 2608d, an user feed screen 2700, a scavenger hunt summary 2702, a badge earned 2704, a merit earned 2706, a VR-AR post 2708, a one or more goe-acheivements 2710, a first goe-acheivement 2710a, a second goe-acheivement 2710b, a third goe-acheivement 2710c, a hidden merits available now indicator 2712, a friends screen 2800, an users friend zone 2802, a one or more friends 2804, a first friend 2804a, a second friend 2804b, a third friend 2804c, a fourth friend 2804d, a one or more activate notifications buttons 2806, a first activate notifications button 2806a, a second activate notifications button 2806b, a third activate notifications button 2806c, a fourth activate notifications button 2806d, a one or more unfriend buttons 2808, a first unfriend button 2808a, a second unfriend button 2808b, a third unfriend button 2808c, a fourth unfriend button 2808d, a one or more cancel buttons 2810, a first cancel button 2810a, a second cancel button 2810b, a third cancel button 2810c, a fourth cancel button 2810d, a friends search area 2812, a search query 2814, a menu screen 2902, a my profile button 2904, an alerts button 2906, a friends button 2908, a channels button 2910, an U.S. top tier button 2912, a logout button 2914, an user profile and system data screen 3000, a tab group 3001, an user's friends tab 3002, an user's assets tab 3004, an user's flicks tab 3006, an user's activities tab 3008, an user's merits tab 3010, an user's badges tab 3012, a created badges tab 3014, a created badges tab 3016, a create channel tab 3018, an users list 3020, a friends list 3022, an add-remove buttons 3024, a create asset blank 3102, a create asset button 3104, an user assets list 3106, a new flick blank 3202, a create flick button 3204, a flick list 3206, an user assets list 3208, an assets in flick list 3210, an add-remove buttons 3212, an activities list 3302, a date-time column 3302a, a description column 3302b, a new asset dialog 3402, a cancel button 3404, a retake button 3406, an asset options 3408, an add to status button 3410, an add to horizon button 3412, an add to camera roll 3414, an add to my flick zone 3416, an add to first flick 3416a, an add to second flick 3416b, a create new flick 3418, a make private 3420, a new asset 3422, an add new flick screen 3502, an add friends zone 3504, a friends search zone 3506, a search query 3508, a friend list area 3510, a first friend 3510a, a second friend 3510b, a third friend 3510c, an added friends zone 3512, a first friend 3512a, a third friend 3512b, a fourth friend 3512c, a location summary zone 3514, a region 3514a, a state 3514b, a county 3514c, a create new button 3516, an add custom merit blank 3602, a create merit button 3604, a created merits list 3606, an all activates list 3608, a quantity blank 3610, a required activates list 3612, an add-remove button 3614, a create badge blank 3702, a create badge button 3704, a badges list 3706, a merits list 3708, a quantity blank 3710, a merits required list 3712, an add-remove buttons 3714, a channels list 3802, a channel properties window 3804, a delete channel button 3806, a new channel button 3808, a set start date buttons 3810, a set end date buttons 3812, a software system use method 5402, a collecting composite assets step 5402a, a verification of assets step 5402b, a sharing step 5402c, a creating a curated setting files step 5402d, a closing a channels step 5402e, a preserving said curated setting files step 5402f, an asset progression chart 5500, a one or more tracked activities or interactions 5502, a one or more assets 5504, a one or more images 5504a, a one or more videos 5504b, a one or more audio files 5504c, a one or more notes 5504d, a one or more virtual reality files 5504e, a one or more augmented reality files 5504f, a one or more stories 5506, a one or more flicks 5508, a one or more curated setting files 5510, a one or more asset layers 5512, a raw asset layer 5512a, a composite asset layer 5512b, and a curated asset layer 5512c.

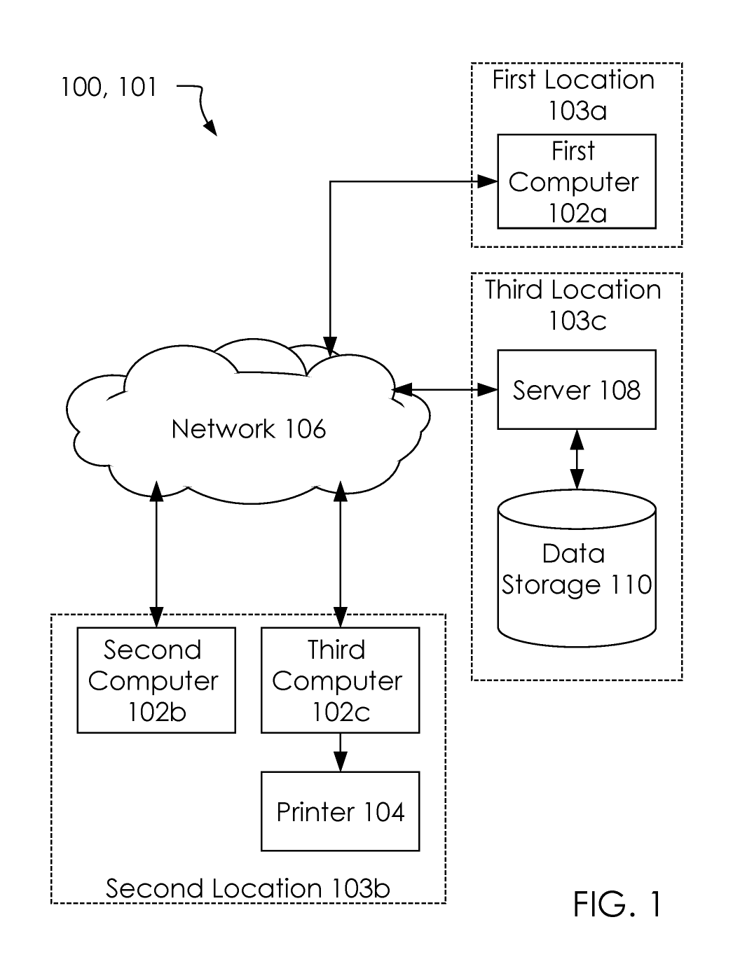

FIG. 1 illustrates a flow chart view of a first network configuration 100.

In one embodiment, said first network configuration 100 can comprise said one or more computers 102, said printer 104, said network 106, said server 108 and said data storage 110.

In one embodiment, said one or more computers 102 can comprise said first computer 102a, said second computer 102b and said third computer 102c.

In one embodiment, said data storage 110 can comprise said data storage 110a.

In one embodiment, said software system 101 can comprise said software system 101, said one or more computers 102, said network 106, said server 108, said data storage 110 and said data storage 110a.

In one embodiment, said first location can comprise a field location. In one embodiment, said one or more computers can communicate on a network 106, which can connect to a one or more servers (such as a server 108). In one embodiment, a printer 104 can be hardwired to said first computer 102a (not illustrated here), or said printer 104 can connect to one of said one or more computers (such as said third computer 102c, illustrated) via network 106.

Said network 106 can be a local area network (LAN), a wide area network (WAN), a piconet, or a combination of LANs, WANs, or piconets. One illustrative LAN is a network within a single business. One illustrative WAN is the Internet.

In one embodiment, said server 108 represents at least one, but can be many servers, each connected to said network 106. Said server 108 can connect to a data storage 110. Said data storage 110 can connect directly to said server 108, as shown in FIG. 1, or may exist remotely on said network 106. In one embodiment, said data storage 110 can comprise any suitable long-term or persistent storage device and, further, may be separate devices or the same device and may be collocated or distributed (interconnected via any suitable communications network).

Said verified media files feed zone 2210 can comprise a hub within a channel. Said current channel title 2204 can be leased or sponsored by a sponsor user for a period of time. In one embodiment, a sponsor can manage aspects of said current channel title 2204 during the period of their sponsorship.

Said navigation bar 828 can be present on one or more or all screens within said software system 101, as illustrated below and known in the art.

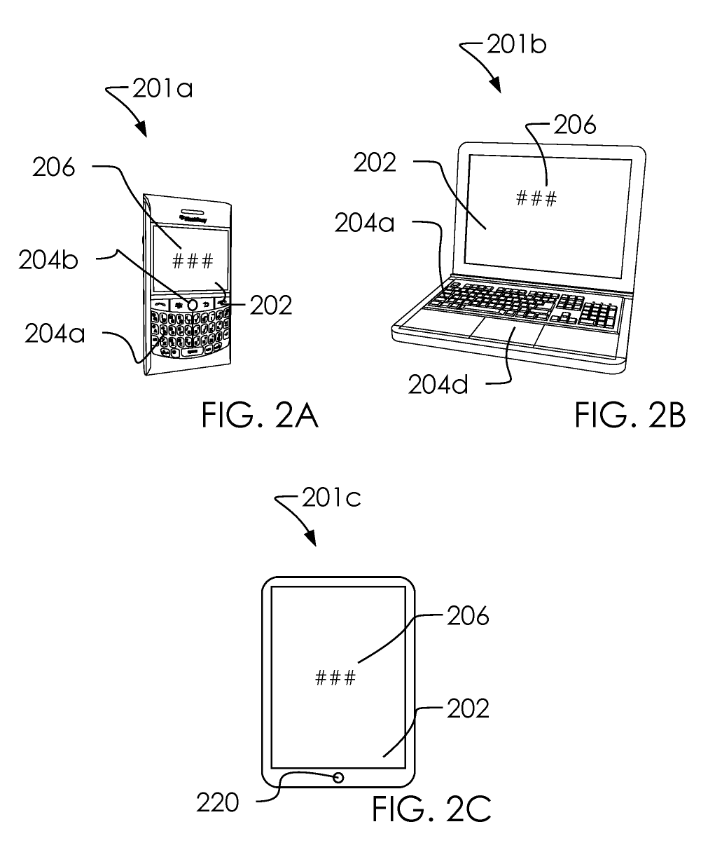

FIG. 2A illustrates a perspective overview view of a mobile phone 201a.

FIG. 2B illustrates a perspective overview view of a personal computer 201b.

FIG. 2C illustrates a perspective overview view of a tablet 201c.

In one embodiment, said tablet 201c can comprise said screen 202, said one or more input devices 204, said data 206 and said home button 220.

In one embodiment, said personal computer 201b can comprise said screen 202, said one or more input devices 204 and said data 206.

In one embodiment, said mobile phone 201a can comprise said screen 202, said one or more input devices 204 and said data 206.

In one embodiment, said one or more input devices 204 can comprise said keyboard 204a, said trackball 204b, said one or more cameras 204c and said track pad 204d.

In one embodiment, said one or more computers 102 can comprise said mobile phone 201a, said personal computer 201b and said tablet 201c.

In the last several years, the useful definition of a computer has become more broadly understood to include mobile phones, tablet computers, laptops, desktops, and similar. For example, Microsoft®, have attempted to merge devices such as a tablet computer and a laptop computer with the release of “Windows® 8”. In one embodiment, said one or more computers each can include, but is not limited to, a laptop (such as said personal computer 201b), desktop, workstation, server, mainframe, terminal, a tablet (such as said tablet 201c), a phone (such as said mobile phone 201a), and-or similar. Despite different form-factors, said one or more computers can have similar basic hardware, such as a screen 202 and a one or more input devices (such as a keyboard 204a, a trackball 204b, a one or more cameras 204c, a wireless—such as RFID—reader, a track pad 204d, and-or a home button 220). In one embodiment, said screen 202 can comprise a touch screen. In one embodiment, said track pad 204d can function similarly to a computer mouse as is known in the art. In one embodiment, said tablet 201c and-or said personal computer 201b can comprise a Microsoft® Windows® branded device, an Apple® branded device, or similar. In one embodiment, said tablet 201c can be an X86 type processor or an ARM type processor, as is known in the art.

Said media roll up system 100 can comprise a data 206. In one embodiment, said data 206 can comprise data related to financial transactions.

In one embodiment, said one or more computers can be used to input and view said data 206. In one embodiment, said data 206 can be input into said one or more computers by taking pictures with one of said one or more camera 204c, by typing in information with said keyboard 204a, or by using gestures on said screen 202 (where said screen 202 is a touch screen). Many other data entry means for devices similar to said one or more computers are well known and herein also possible with data 206. In one embodiment, said first computer 102a can comprise an iPhone®, a BlackBerry®, a smartphone, or similar. In one embodiment, one or more computers can comprise a laptop computer, a desktop computer, or similar.

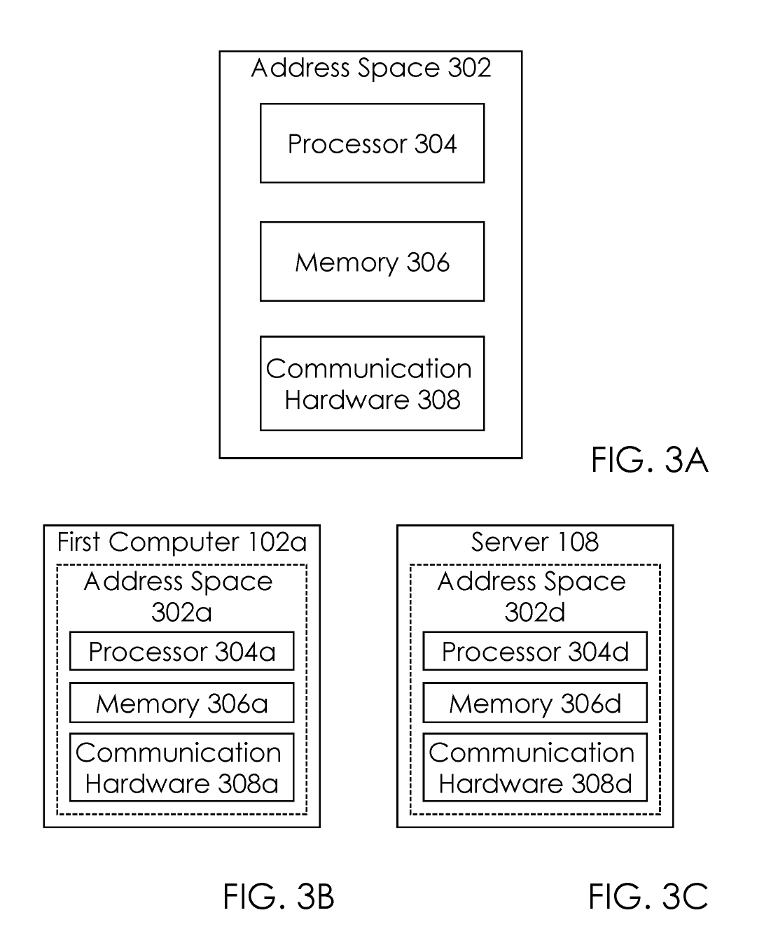

FIG. 3A illustrates block diagram view of an address space 302a.

FIG. 3B illustrates block diagram view of a first computer 102a.

FIG. 3C illustrates block diagram view of a server 108.

In one embodiment, said address space 302 can comprise said address space 302a, said address space 302b, said address space 302c, said address space 302d, said processor 304, said memory 306 and said communication hardware 308.

In one embodiment, said processor 304 can comprise said processor 304a, said processor 304b, said processor 304c and said processor 304d.

In one embodiment, said memory 306 can comprise said memory 306a, said memory 306b, said memory 306c and said memory 306d.

In one embodiment, said communication hardware 308 can comprise said communication hardware 308a, said communication hardware 308b, said communication hardware 308c and said communication hardware 308d.

In one embodiment, said first computer 102a can comprise said address space 302a.

In one embodiment, said server 108 can comprise said address space 302d.

Each among said one or more computers and said server 108 can comprise an embodiment of address space 302.

In one embodiment, said processor 304 can comprise a plurality of processors, said memory 306 can comprise a plurality of memory modules, and said communication hardware 308 can comprise a plurality of communication hardware components. In one embodiment, said data 206 can be sent to said processor 304; wherein, said processor 304 can perform processes on said data 206 according to an application stored in said memory 306, as discussed further below. Said processes can include storing said data 206 into said memory 306, verifying said data 206 conforms to a one or more preset standards, or ensuring a required set among said required data 206 has been gathered for said data management system and method. In one embodiment, said data 206 can include data which said one or more computers can populate automatically, such as a date and a time, as well as data entered manually. Once a portion of gathering data has been performed said data 206 can be sent to said communication hardware 308 for communication over said network 106. Said communication hardware 308 can include a network transport processor for packetizing data, communication ports for wired communication, or an antenna for wireless communication.

In one embodiment, said data 206 can be collected in one or more computers and delivered to said server 108 through said network 106.

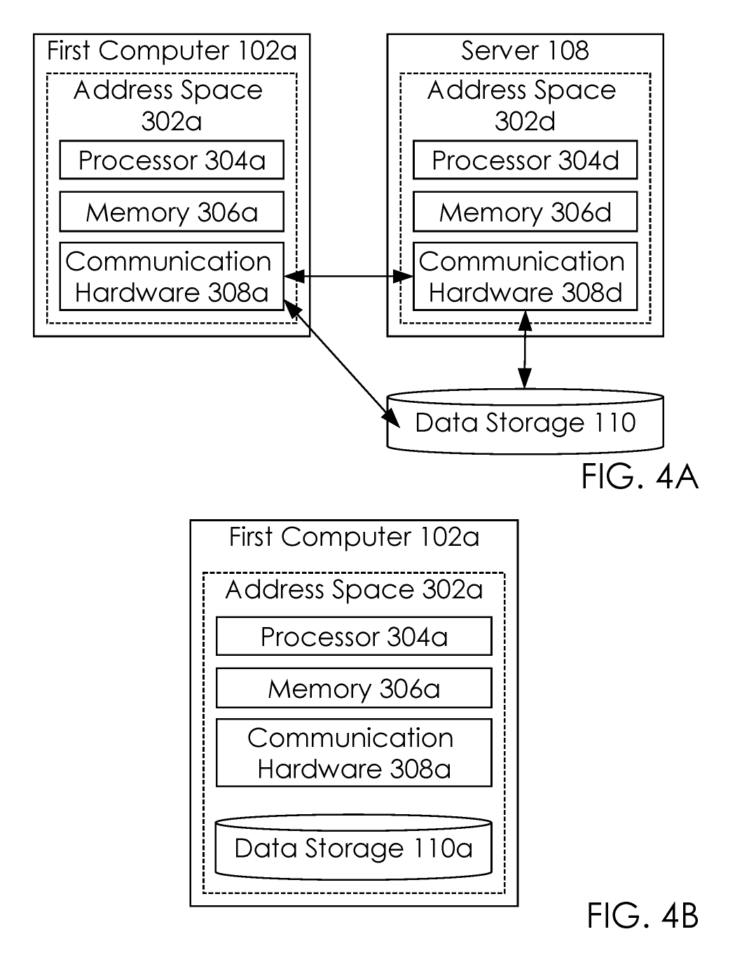

FIG. 4A illustrates a flow chart view of a one or more computers 102.

FIG. 4B illustrates block diagram view of a first computer 102a.

In the first embodiment, said communication hardware 308a and said communication hardware 308d can send and receive data to and from one another and or can communicate with said data storage 110 across said network 106. Likewise, in the second embodiment, data storage 110 can be embedded inside of said one or more computers as a data storage 110a, which may speed up data communications by said media roll up system 100. In another embodiment, said data can be stored temporarily on said data storage 110a and later moved to said data storage 110 for backup and sharing purposes.

As illustrated in FIG. 4A, in one embodiment, said server 108 can comprise a third party data storage and hosting provider or privately managed as well.

As illustrated in FIG. 4B, said data storage 110 can be located on said first computer 102a, here labeled as said data storage 110a. Thus, said first computer 102a can operate without a data connection out to said server 108 while performing said system and method for field capture of data.

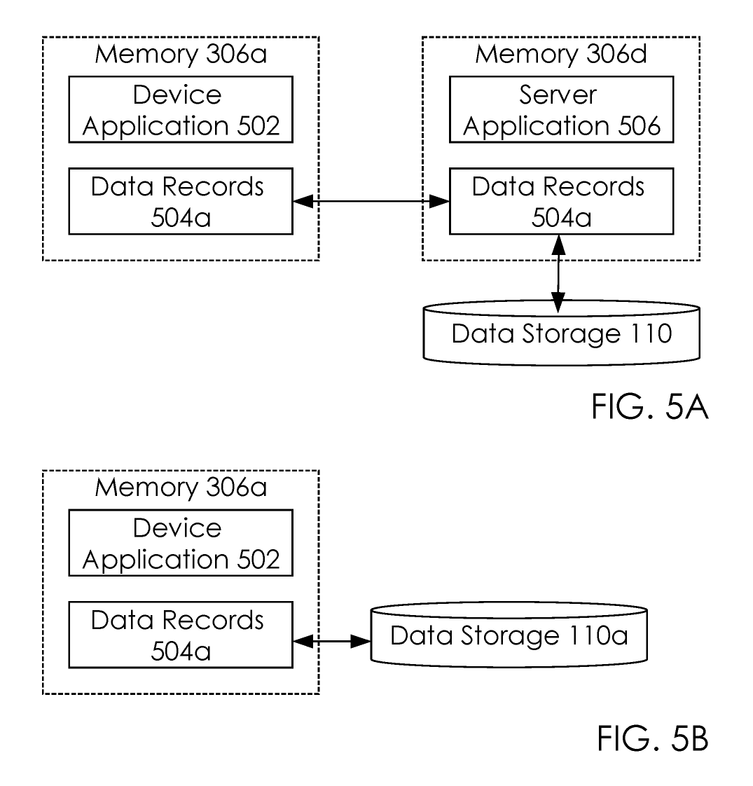

FIG. 5A illustrates memory space view of a one or more computers 102.

FIG. 5B illustrates block diagram view of a memory 306a.

In one embodiment, said memory 306a can comprise said data records 504a.

In one embodiment, said memory 306b can comprise said data records 504b.

In one embodiment, said memory 306c can comprise said data records 504c.

In one embodiment, said memory 306d can comprise said data records 504d.

In one embodiment, said software system 101 can comprise said device application 502 and said server application 506.

As illustrated in FIG. 5A, in one embodiment, said media roll up system 100 can process said data 206 on said first computer 102a and-or said server 108. For example, in one embodiment, said memory 306a can comprise a device application 502 capable of generating a data records 504 from user inputs or, otherwise, processing said data records 504 delivered to said device application 502 from said data storage 110. In one embodiment, said data records 504 can be transferred between said device application 502 on said memory 306a of said first computer 102a and a server application 506 in said memory 306d of said server 108. In one embodiment, said server 108 can be useful for processing said data 206, as is known in the art. As illustrated in FIG. 5B, in another embodiment, said server 108 can be removed from the flow diagram entirely as said memory 306a is capable of processing said data records 504 and-or said data 206 without the assistance of said server 108.

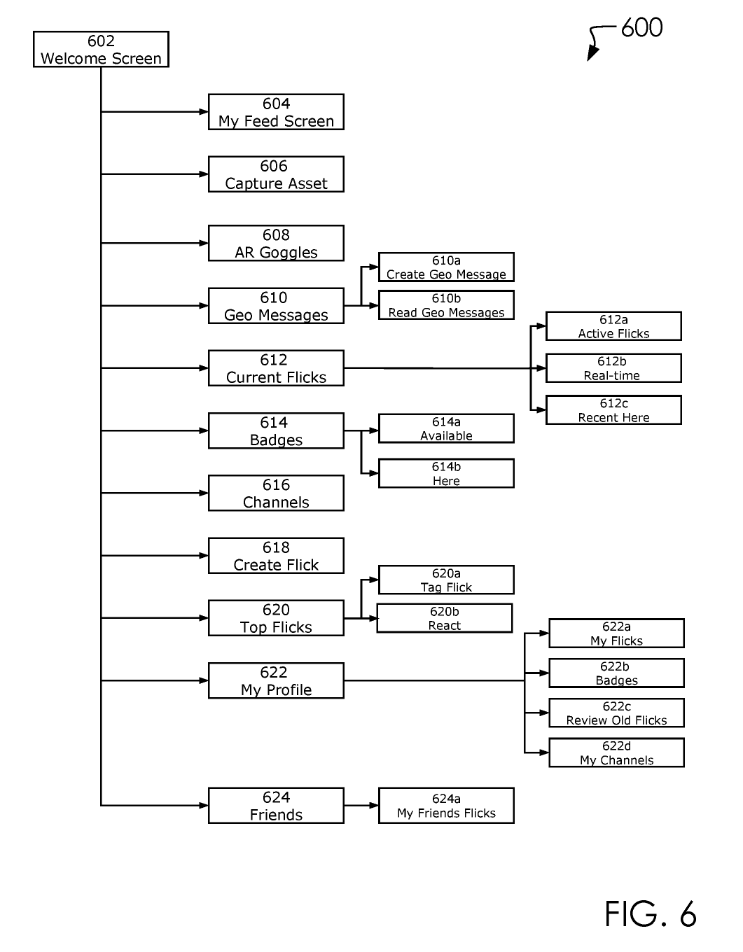

FIG. 6 illustrates a flow chart view of a navigation diagram 600.

In one embodiment, said navigation diagram 600 can comprise said welcome screen 602, said my feed 604, said capture asset 606, said AR goggles 608, said geo-messages 610, said current flicks 612, said badges 614, said channels 616, said create flick 618, said top flicks 620, said my profile 622 and said friends 624.

In one embodiment, said geo-messages 610 can comprise said create geo-message 610a and said read geo-messages 610b.

In one embodiment, said current flicks 612 can comprise said active flicks 612a, said real-time flicks 612b and said recent flicks here 612c.

In one embodiment, said badges 614 can comprise said available badges 614a and said badges here 614b.

In one embodiment, said top flicks 620 can comprise said tag flick 620a.

In one embodiment, said my profile 622 can comprise said my flicks 622a, said my badges 622b, said review old flicks 622c and said my channels 622d.

In one embodiment, said friends 624 can comprise said my friends flicks 624a.

Said navigation diagram 600 can summarize how a user might navigate a one or more screens within said software system 101, as is known in the art. Details of each block in this diagram will be included below.

One goal of said software system 101 is toi enable people to make various connections. For example, two people meet on the beach and communicate later over a common subject matter.

Also, it is noted that this disclosure uses the beach as the setting for using said software system 101. This is a first concept of the creators of this system but should not be considered as a limitation on the scope of the usefulness of said software system 101, which is not implicitly restricted to coastal areas.

Next, said software system 101 uses the term “flicks” rather than “posts” as is common in the market today. A flick can be distinguished as a unit of information being shared in the context of said software system 101, as discussed below.

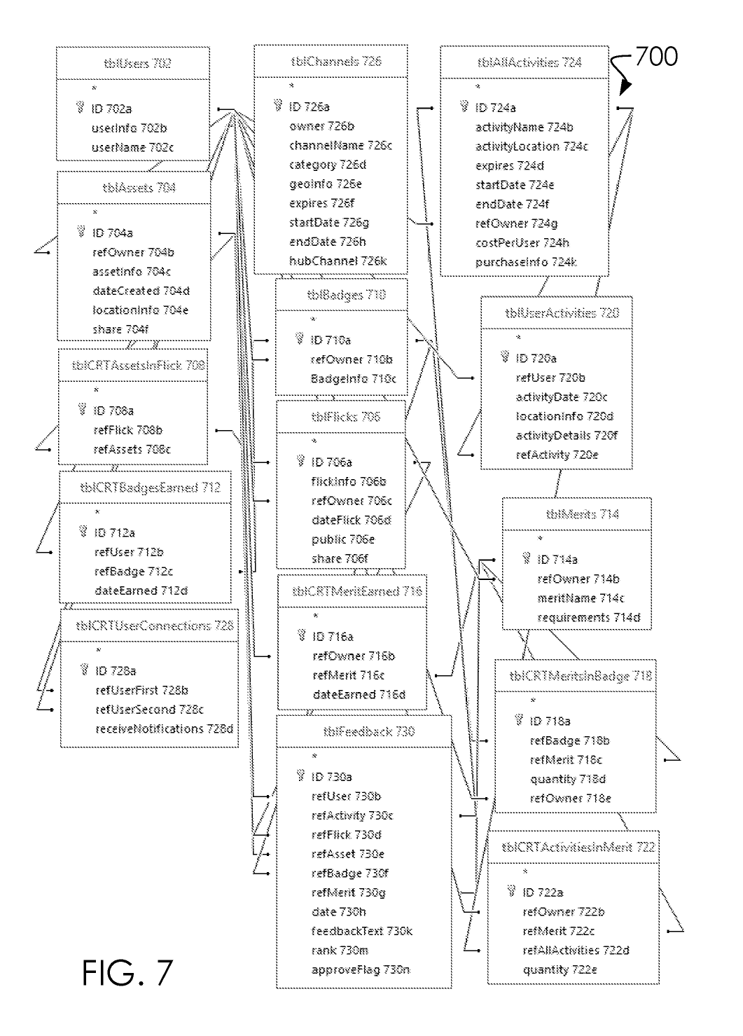

FIG. 7 illustrates a flow chart view of a database tables 700.

In one embodiment, said database tables 700 can comprise said tblUsers 702, said tblAssets 704, said tblFlicks 706, said share 706f, said tblCRTAssetsInFlicks 708, said tbleBadges 710, said tblCRTBadgesEarneds 712, said tblmerits 714, said tblCRTmeritEarneds 716, said tblCRTmeritsInBadges 718, said tblUserActivities 720, said tblCRTActivitiesInmerits 722, said tblAllActivities 724, said tblChannels 726, said tblCRTUserConnections 728 and said tblFeedback 730.

In one embodiment, said tblUsers 702 can comprise said ID 702a, said userInfo 702b and said userName 702c.

In one embodiment, said tblAssets 704 can comprise said ID 704a, said refOwner 704b, said assetInfo 704c, said dateCreated 704d, said locationInfo 704e and said share 704f.

In one embodiment, said tblFlicks 706 can comprise said ID 706a, said flickInfo 706b, said refOwner 706c, said dateFlick 706d and said share 706f.

In one embodiment, said tblCRTAssetsInFlicks 708 can comprise said ID 708a, said refFlick 708b and said refAssets 708c.

In one embodiment, said tbleBadges 710 can comprise said ID 710a, said refOwner 710b and said BadgeInfo 710c.

In one embodiment, said tblCRTBadgesEarneds 712 can comprise said ID 712a, said refOwner 712b, said refBadge 712c and said dateEarned 712d.

In one embodiment, said tblmerits 714 can comprise said ID 714a, said refOwner 714b, said meritName 714c and said requirements 714d.

In one embodiment, said tblCRTmeritEarneds 716 can comprise said ID 716a, said refOwner 716b, said refmerit 716c and said dateEarned 716d.

In one embodiment, said tblCRTmeritsInBadges 718 can comprise said ID 718a, said refBadge 718b, said refmerit 718c, said quantity 718d and said refOwner 718e.

In one embodiment, said tblUserActivities 720 can comprise said ID 720a, said activityDate 720b, said locationInfo 720c, said activityDetails 720d and said refActivity 720e.

In one embodiment, said tblCRTActivitiesInmerits 722 can comprise said ID 722a, said refOwner 722b, said refOwner 722c, said refAllActivities 722d and said quantity 722e.

In one embodiment, said tblAllActivities 724 can comprise said ID 724a, said activityName 724b, said activityLocation 724c, said expires 724d, said startDate 724e, said endDate 724f, said refOwner 724g, said costPerUser 724h and said purchaseInfo 724k.

In one embodiment, said tblChannels 726 can comprise said ID 726a, said owner 726b, said channelName 726c, said category 726d, said geoInfo 726e, said expires 726f, said startDate 726g, said endDate 726h and said hubChannel 726k.

In one embodiment, said tblCRTUserConnections 728 can comprise said ID 728a, said refUserFirst 728b, said refUserSecond 728c and said receiveNotifications 728d.

In one embodiment, said tblFeedback 730 can comprise said ID 730a, said refUser 730b, said refactivity 730c, said refFlick 730d, said refAsset 730e, said refBadge 730f, said refMerit 730g, said date 730h, said feedbackText 730k, said rank 730m and said approveFlag 730n.

In one embodiment, said software system 101 can comprise said database tables 700.

In one embodiment, said database tables 700 can comprise a set of relationships between one or more database tables. A starting point for said software system 101 can comprise a set of users, summarized in said tblUsers 702. Each user of within said software system 101 can have one or more settings associated with them, as is known in the art. For brevity, this disclosure has omitted the details such as user roles, passwords, contact information, hometown, favorite book, etc. Such information is implied in the term social network and would be obvious in this context. Instead, this disclosure focuses on showing the nature of the data relationships within said database tables 700.

It is conceded that said database tables 700 is a complex diagram of tables and their respective relationships. Nomenclature and details below will further enlighted this discussion. First, where a field has the prefix “ref” that field is a reference to another table for use in look ups and relative information. Next, rather than writing part/element numbers next to each field and table name, these are included as though part of the field name themselves. For example part “tblUsers 702” comprise a field which may in fact be named “ID” but we include the element number for simplicity.

Next, “CRT” means “cross reference table” and indicates that a table is used to create a relationship between two other tables, as is known in the art.

A discussion of the table names, field names, and roles will be held below as these digital assets are employed to disclose the current system.

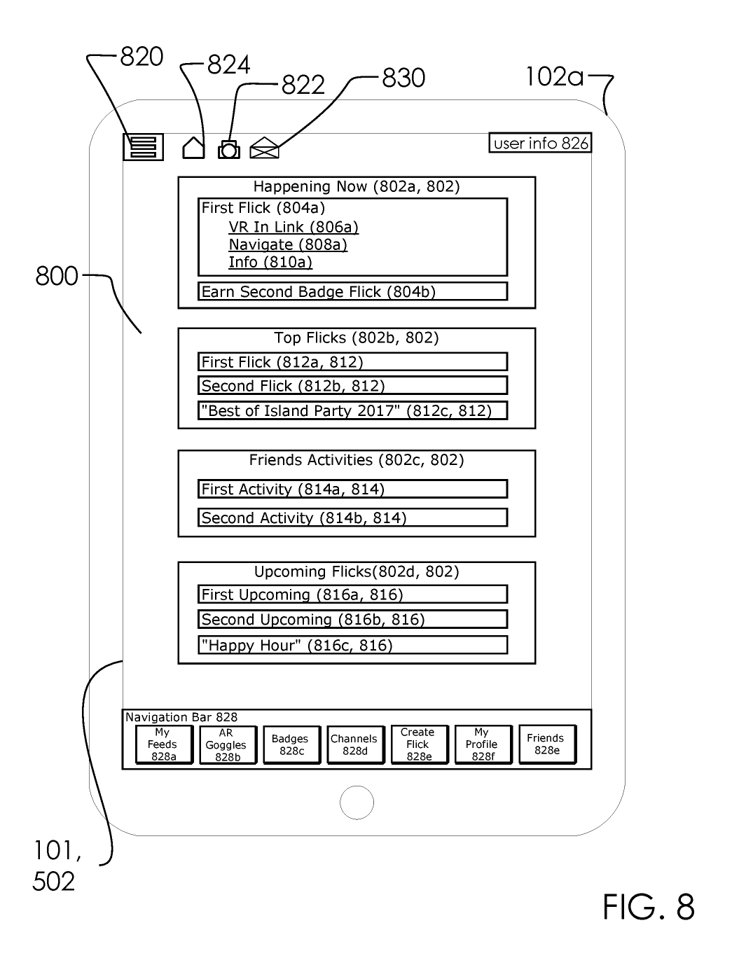

FIG. 8 illustrates an elevated overview view of a welcome screen 800.

In one embodiment, said welcome screen 800 can comprise said one or more display windows 802, said one or more real time flicks 804, said one or more top flicks 812, said one or more friends flicks 814, said one or more upcoming flicks 816, said menu button 820, said capture button 822, said home button 824, said user info indicator 826, said navigation bar 828 and said messaging button 830.

In one embodiment, said one or more display windows 802 can comprise said happening now flicks window 802a, said top flicks window 802b, said friends flicks window 802c and said upcoming flicks window 802d.

In one embodiment, said happening now flicks window 802a can comprise said one or more real time flicks 804, said first flick 804a and said earn second badge flick 804b.

In one embodiment, said top flicks window 802b can comprise said one or more top flicks 812, said first top flick 812a, said second top flick 812b and said Best of Island Party 2017 flick 812c.

In one embodiment, said friends flicks window 802c can comprise said one or more friends flicks 814, said first friends flick 814a, said second friends flick 814b and said happy hour upcoming flick 816c.

In one embodiment, said upcoming flicks window 802d can comprise said one or more upcoming flicks 816, said first upcoming flick 816a, said second upcoming flick 816b and said happy hour upcoming flick 816c.

In one embodiment, said one or more real time flicks 804 can comprise said first flick 804a and said earn second badge flick 804b.

In one embodiment, said first flick 804a can comprise said VR-in link 806a, said navigate link 808a and said info link 810a.

In one embodiment, said one or more top flicks 812 can comprise said first top flick 812a, said second top flick 812b and said Best of Island Party 2017 flick 812c.

In one embodiment, said one or more upcoming flicks 816 can comprise said first upcoming flick 816a, said second upcoming flick 816b and said happy hour upcoming flick 816c.

In one embodiment, said one or more friends flicks 814 can comprise said first friends flick 814a and said second friends flick 814b.

In one embodiment, said navigation bar 828 can comprise said my feeds button 828a, said AR goggles button 828b, said badges button 828c, said channels button 828d, said create flick button 828e, said my profile button 828f and said friends button 828g.

In one embodiment, said software system 101 can comprise said welcome screen 800.

Said happening now window 802a can comprise a window displaying activates, events and flicks which are occurring now. Said flicks which are “happening now” can be divided into two types; first there is a real-time flick and second there is an active flick.

Real-time flicks are those which can be interacted with remotely through augmented reality (“AR”) or virtual reality (“VR”) systems, as is known in the art. Examples of AR include Microsoft HoloLens and examples of VR include Oculus Rift, Google Cardboard, and similar.

Where, a user can click on a real-time event in said happening now window 802a and participate by VR/AR remotely but in real-time. Alternatively, a user can see one among said active events and see passive posts and information about an event that is ongoing.

In one embodiment, said 804 can comprise badges and flicks which are available to a particular user. For example, if a user's hardware doesn't support AR or VR then said VR-in link 806a can be omitted. Further, if a first badge hasn't been earned, a second badge might be omitted.

One objective of said software system 101 is to encourage end users to attend or interact with activities which are posted to said happening now window 802a.

Said top flicks window 802b can comprise a list of promoted and/or notable flicks which are posted to the system. More will be said about “flicks” later in this disclosure. In brief, said flicks are something like a social media post but with one or more new attributes. Flicks can be created manually or automatically based on settings of users and those of said software system 101.

Said friends activities window 802c and said upcoming flicks window 802d can comprise the well-known functions of such systems, as is known in the art.

Said menu button 820 and said navigation bar 828 can take users to more settings. Said user info indicator 826 can comprise a summary of which user is logged in and quick access to user information. Said home button 824 can take said software system 101 back to said welcome screen 800. Said capture button 822 can comprise a process for creating new assets, as discussed below.

In one embodiment, said welcome screen 600 can be used for user authentication as is known in the art. In one embodiment, said welcome screen welcome screen 600 can be reached through an application on a mobile device, as illustrated, through browser, and-or a non-mobile computer app.

In one embodiment, said login zone 606 can be used for existing users of said device application 502 and said new user zone 608 can be used by new users of said device application 502. In one embodiment, said login zone 606 can request existing credentials with said username prompt 622 and said password prompt 624. Likewise, said new user zone 608 can begin a process of setting up a new client account with said create username prompt 626 and said create password prompt 628. Said log in button 610 and create user account button 614 can be used to submit data to said device application 502.

For illustrative purposes, we will be using a user account referred to as said current user 612, which is a username and password combination which will serve as a credential for access to said device application 502.

In one embodiment, said menu button 820, said capture button 822, said home button 824, said user info indicator 826 and said navigation bar 828 can be hidden during normal use of said device application 502. These can be brought back to the front through a tap of the screen, or other GUI mans, as is known in the art. In one embodiment, said device application 502 can be viewed in an AR or VR headset; wherein, said menus can be hidden until the headset is tapped or otherwise interacted with to cause the menus to repear.

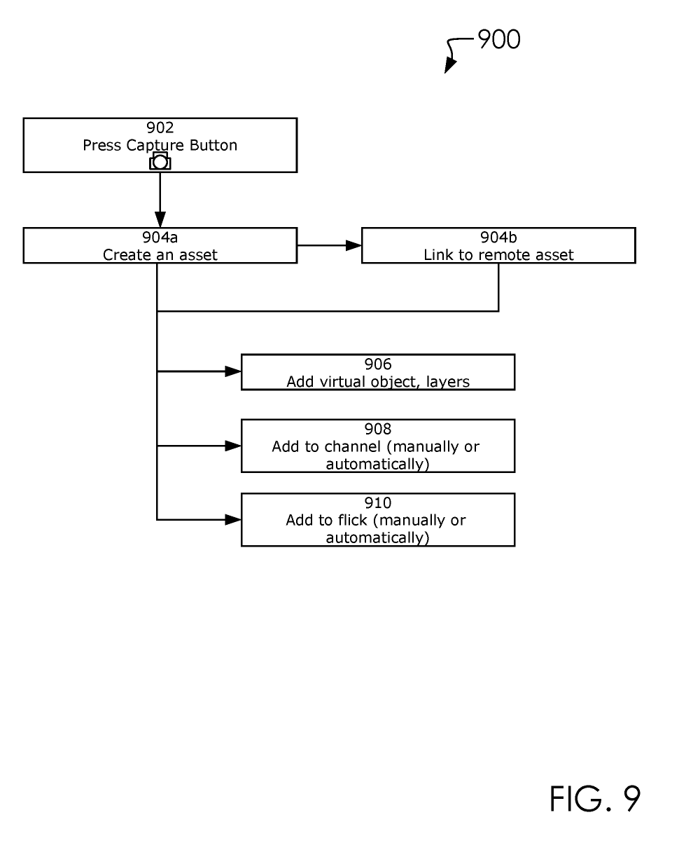

FIG. 9 illustrates a flow chart view of an asset capture process 900.

In one embodiment, said asset capture process 900 can comprise said press capture button step 902, said create an asset step 904a, said link to remote asset step 904b, said add virtual object option 906, said add to channel option 908 and said add to flick option 910.

In one embodiment, said software system 101 can comprise said asset capture process 900.

In one embodiment, this disclosure uses the term “asset” to generally refer to a digital file such as a picture, video, VR, AR, audio file, collage, audio stream, video stream, or similar. In one embodiment, assets can be the building blocks of various other things within said 101, such as flicks, merits and badges.

For said create an asset step 904a, said device application 502 of said software system 101 can provide a classic or advanced interface for capturing new assets. For example, a camera app for capturing video, audio or pictures. VR and AR may require additional equipment such as 360 degree cameras and advanced immersive audio sensors, as is known in the art or would be understood to one in the art.

Likewise, said link to remote asset step 904b can allow said device application 502 to link to a resource on another service such as MS Paint 3D, YouTube.com VR events, live streams, or similar, as is known in the art.

In one embodiment, said add virtual object option 906 can comprise a step of hiding or placing additional information in a meta layer or a separate visual layer of a visual asset, such as a picture. For example, in one embodiment, a picture can be broken into multiple layers; wherein, a user input can remove a top layer from an image to expose a lower layer. Similarly, videos, AR and VR can be in multiple layers. This multi-layer approach can provide fun and discovery opportunities for users of said software system 101.

Said add to channel option 908 can comprise adding a new asset to a channel.

Said add to flick option 910 can comprise adding an asset to a flick. This step can be done automatically based on settings, analysis of the new asset, analysis of the circumstance of collecting said asset such as location, time or similar, and/or manual entry.

Said add to flick option 910 can comprise adding a new asset to a flick.

In one embodiment, not selecting an action after creating an asset can cause said new asset to be collected in a holding reservoir or into a camera roll on a user's computer (such as said one or more computers 102 or said mobile phone 201a).

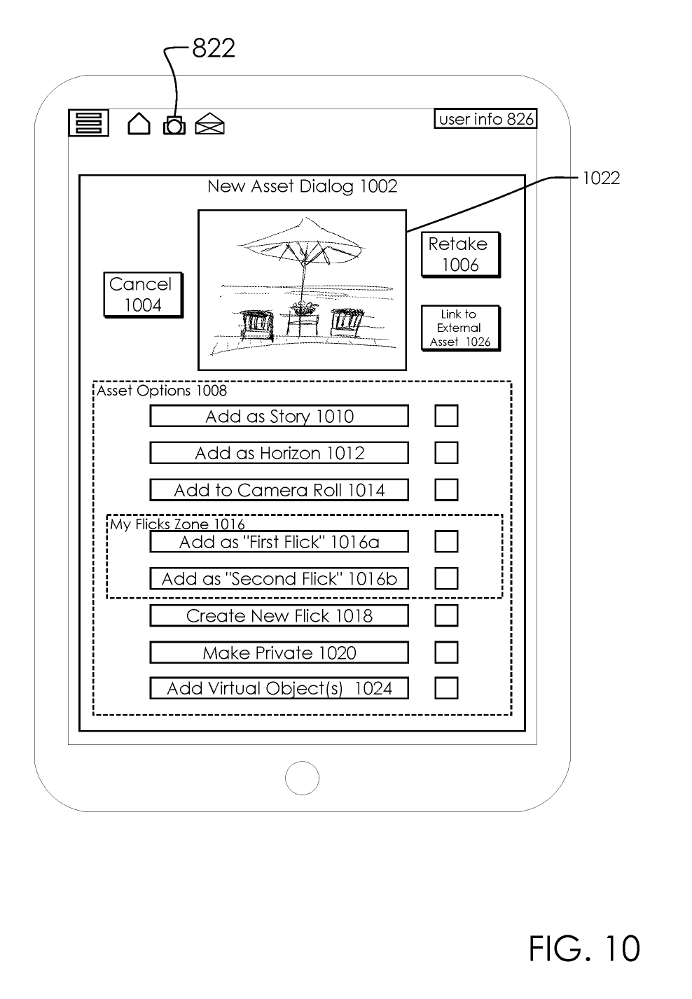

FIG. 10 illustrates GUI view of a new asset dialog 1002.

In one embodiment, said new asset dialog 1002 can comprise said cancel button 1004, said retake button 1006, said asset options 1008, said new asset 1022 and said link to external asset 1026.

In one embodiment, said asset options 1008 can comprise said add as story button 1010, said add to horizon button 1012, said add to camera roll 1014, said add to my flick zone 1016, said create new flick 1018, said make private 1020 and said add virtual object 1024.

In one embodiment, said add to my flick zone 1016 can comprise said add to first flick 1016a and said add to second flick 1016b.

Said capture button 822 can bring a user to said new asset dialog 1002.

Said new asset dialog 1002 can comprise a one or more actions to perform on said new asset 1022.

In one embodiment, said add to my event zone 1016 can comprise existing apps. In one embodiment, said create new event 1018 can create a new event. In one embodiment, said make private 1020 can make other categorizations within said asset options 1002 without making said new asset 1022 publicly available yet.

In one embodiment, clicking either cancel button 1004 or said retake button 1006 can cause said new asset 1022 to be discarded.

In one embodiment, said add to camera roll 1014 option can be used to save an image to a local device without further options within said device application 502 being engaged. This can have the effect of removing said new asset 1022 from said device application 502 and corresponding cloud locations.

In one embodiment, options displayed on said new asset dialog 1002, specifically listed in said add to my event zone 1016, can comprise individual or group events, as discussed herein. In one embodiment, items listed in said add to my event zone 1016 can be influenced by user settings and/or user usage trends, as is known in the art.

In one embodiment, said create new event 1018 and said make private 1020 can be hidden in a settings page to simplify this interface and facilitate ease of building a complete database.

In one embodiment, said add virtual object 1024 can allow a user to add a hidden or visible layer to a new asset, as discussed herein.

Here, under said asset options 1008, said add to status button 1010 can comprise a very similar work flow with using one or more of said flicks. One distinction between a story and flick can comprise a publicity setting; wherein, stories default to private (that is friends only) and flicks are public. Further, the asset creator may have a signal for views of private assets such as stories. Additionally, said add as story button 1010 can comprise a real-time shared asset where other users know that the location and time of sharing are fresh. Said add as story button 1010 therefore are useful for indicating and encouraging real-time sharing.

Finally, in one embodiment, said new asset dialog 1002 can allow a user to link to an external asset as discussed in said link to remote asset step 904b, above.

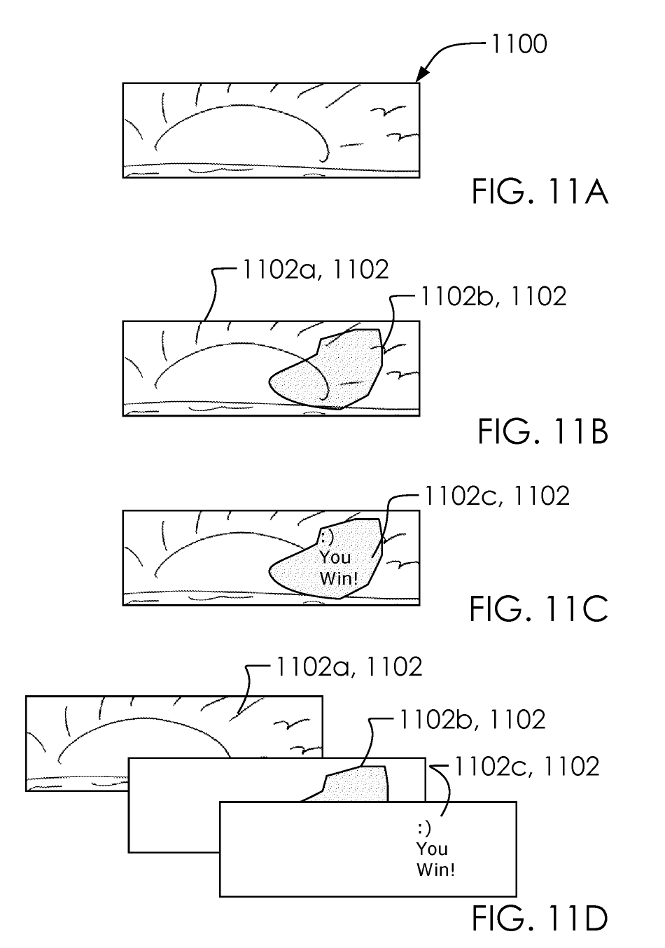

FIG. 11A illustrates an elevated overview view of a layered asset 1100.

FIG. 11B illustrates an elevated overview view of a layered asset 1100.

FIG. 11C illustrates an elevated overview view of a layered asset 1100.

FIG. 11D illustrates an elevated overview view of a layered asset 1100.

said layered asset 1100 can comprise one among said new asset 1022, wherein said lone or more computers 102 have been added to enhance user enjoyment of said software system 101.

Said 1first computer 102a can comprise a visible layer of said new asset 1022.

Said cutout layer 1102b can comprise a burn in effect or a visual signal to inquisitive users that more than one layer exists in one among said new asset 1022.

Said message layer 1102c can comprise a layer bearing information, links, rewards, or other hidden messages.

In one embodiment, said message layer 1102c can comprise a hint for a scavenger hunt, a coupon, a discount, a freebie a song, another asset, flicks, achievements, or similar.

In one embodiment, said one or more layers 1102 can be used in VR and/or AR, wherein, a user of said software system 101 can erase a portion of said visible layer 1102a to expose said cutout layer 1102b and/or said message layer 1102c within a 3D space. User inputs can be recorded or entered by voice command, gestures, typing or similar.

In another embodiment, said one or more computers 102 can comprise filters and similar additions to images that are used in the art. For example, a user of SnapChat® may add a filter or illustrative layer to an image taken. Said software system 101 can comprise a means of removing such layers and/or adding new layers.

In one embodiment, portions of said one or more layers 1102 can be stored in a database table or as vector inputs, as is known in the art.

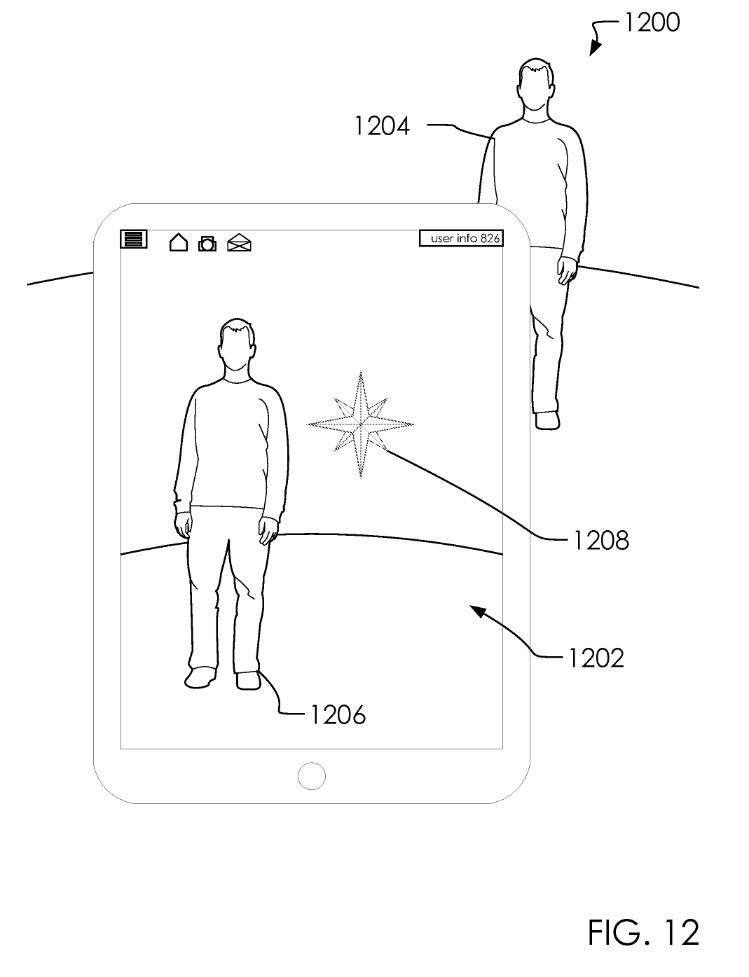

FIG. 12 illustrates a perspective overview view of an AR goggles demonstration 1200.

In one embodiment, said AR goggles demonstration 1200 can comprise said AR software screen 1202, said photograph subject 1204, said real world image portions 1206 and said virtual object portion 1208.

In one embodiment, said software system 101 can comprise said AR goggles demonstration 1200.

In one embodiment, clicking on said AR goggles button 828b can lead said software system 101 to said AR software screen 1202.

In one embodiment, said software system 101 can display said real world image portions 1206 by finding said virtual object portion 1208. One example of this feature can be found with the now popular game known as Pokémon Go®. Likewise, said virtual object portion 1208 can be found by arriving at a location on the map and capturing such objects. Often, said virtual object portion 1208 can be hidden in said 1third computer 102c, as illustrated above, and revealed by user gestures on said 1first computer 102a which can comprise said real world image portions 1206.

Thus, said virtual object portion 1208 can be found to gain badges, merits, activities, goals and similar within said software system 101.

Said virtual object portion 1208 can be created by a user at the time of creating a new activity, merit and/or badges, as discussed below.

In one embodiment, images of said AR software screen 1202 can be captured as a separate asset such as a flat 2D image with said real world image portions 1206 and said virtual object portion 1208.

In one embodiment, messages can be included as said virtual object portion 1208 for public use or for private use. For example, a first user can leave a message for one or more other users which cannot be read by the general user base of said software system 101.

Said software system 101 can continue an evolution of picture taking which has been developing in recent year. Technology has developed from cumbersome photography equipment, to point and shoot, to digital, to smart phones, to 360 degree views, 3D views, animated images, and finally to augmented reality images. Recent announcements include fashion accessories with built in cameras and sensors, such as sunglasses with camera. Users can be creating and viewing assets in real time and overlapping their real vision.

Illustrated in said AR goggles demonstration 1200, is a 2D rendering of said virtual object portion 1208 over the real world in said AR software screen 1202.

Creating a social network for these new image types is an important step as end users need a paradigm for enjoying these assets. Said software system 101 is that platform.

Further, said software system 101 can create a economy that encourages the creation of such new assets by rewarding certain action such as sending them on scavenger hunts, rewarding with merits and badges, and similar. This can be considered a ramification of the social network with the byproduct of high tech image types such as AR, VR and the like.

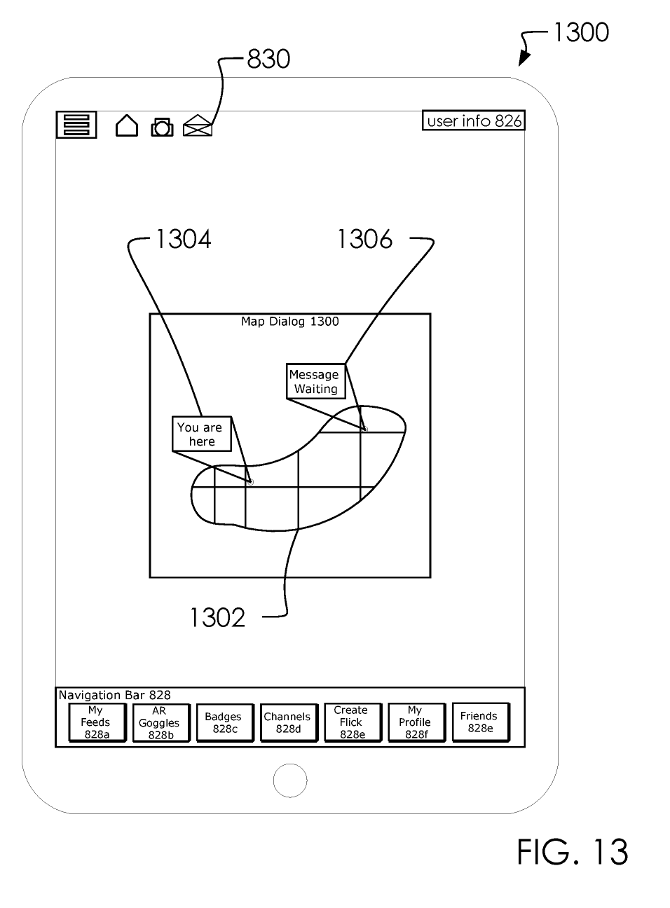

FIG. 13 illustrates an elevated overview view of a map dialog screen 1300.

In one embodiment, said map dialog screen 1300 can comprise said map graphic 1302, said current location 1304 and said message location 1306.

In one embodiment, said software system 101 can comprise said map dialog screen 1300.

In one embodiment, clicking on said messaging button 830 can lead said software system 101 to said map dialog screen 1300.

In one embodiment, said map dialog screen 1300 can depend on the GPS data or other location data to approximate the location of a user or user's device. For example, said software system 101 can estimate that said tablet 201c is located at said current location 1304. Next said software system 101 can reserve a one or more messages which cannot be reviewed until said tablet 201c is located approximate at said message location 1306.

In one embodiment, said message location 1306 can comprise a flick, asset, activity, badge or similar.

In one embodiment, said message location 1306 can expire after a period of time, or otherwise remain publicly available.

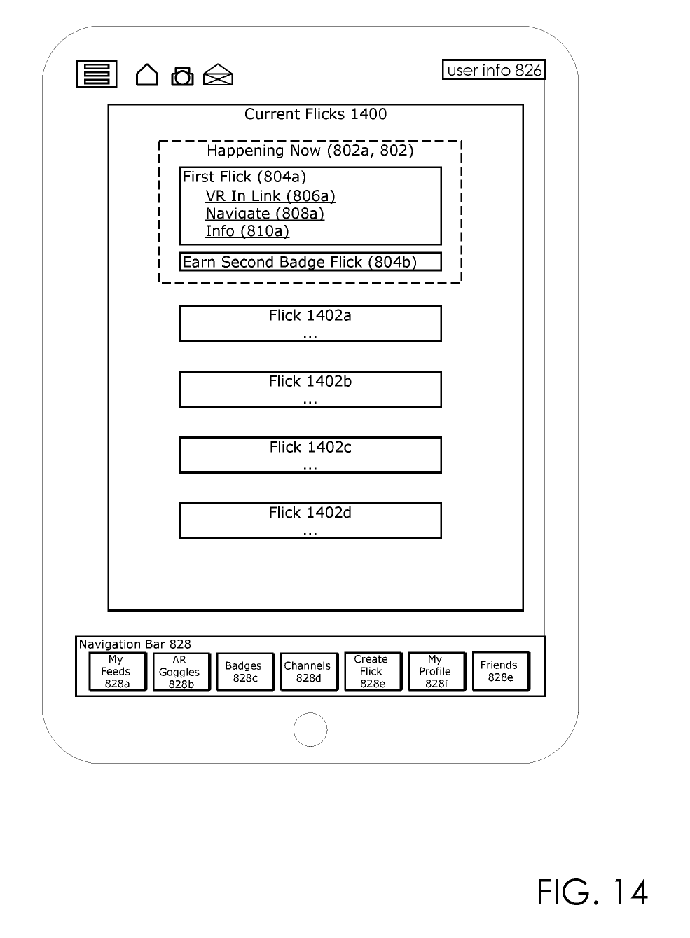

FIG. 14 illustrates an elevated overview view of a current flicks screen 1400.

In one embodiment, said current flicks screen 1400 can comprise said one or more flicks 1402.

In one embodiment, said one or more flicks 1402 can comprise said first flick 1402a, said second flick 1402b, said third flick 1402c and said fourth flick 1402d.

In one embodiment, said software system 101 can comprise said current flicks screen 1400.

Said current flicks screen 1400 can comprise said one or more flicks 1402, which can be drawn from events occurring in real-time, near by, by friends, by sponsors, or similar.

A user can come to said current flicks screen 1400 to determine what is going on near by or with friends. Each of said one or more flicks 1402 can comprise links such as said VR-in link 806a, navigate link 808a and/or said info link 810a, as discussed above.

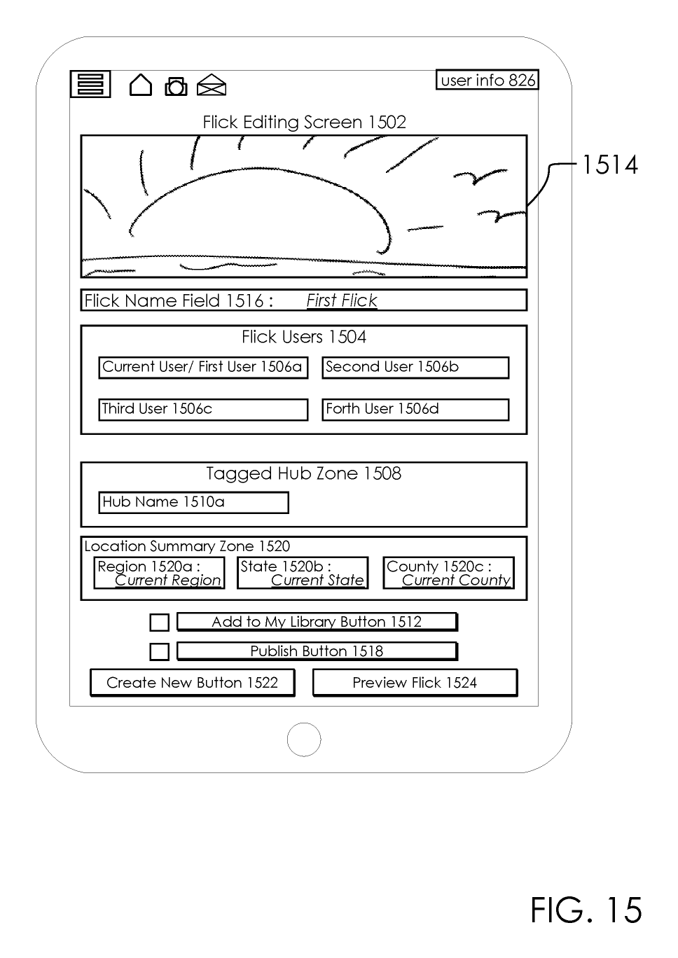

FIG. 15 illustrates an elevated overview view of a flick editing screen 1502.

In one embodiment, said flick editing screen 1502 can comprise said flick users 1504, said tagged hub zone 1508, said add to my library button 1512, said banner image 1514, said flick name field 1516, said publish button 1518, said create-edit button 1522 and said preview flick 1524.

In one embodiment, said one or more flick users 1506 can comprise said first user 1506a, said second user 1506b, said third user 1506c and said forth user 1506d.

In one embodiment, said tagged hub zone 1508 can comprise said hub name 1510a.

In one embodiment, said location summary zone 1520 can comprise said region setting 1520a, said state setting 1520b and said county setting 1520c.

In one embodiment, said event name field 908 can be shown on said flick post final editing screen 1502.

In one embodiment, said banner image 1514.

In one embodiment, said flick users 1504 can comprise users with permission to view and-or edit contents within an event being edited.

In one embodiment, said tagged hub zone 1508 can comprise tags such as hash tags to identify the current event with a theme or keyword, as is known in the art.

In one embodiment, clicking said add to add to my library button 1512 can cause an event to be added to a library (more on this to come) for said current user.

In one embodiment, clicking said publish button 1518 can cause an event to become publicly available for viewing and comment, as is known in the art.

In one embodiment, said tagged hub zone 1508 can be added automatically.

In one embodiment, said flick users 1504 can be left empty. In that case, the current flick will be visible according to publishing settings, but not editable by outside parties.

In one embodiment, clicking said preview flick 1524 can allow a user to preview the current flick.

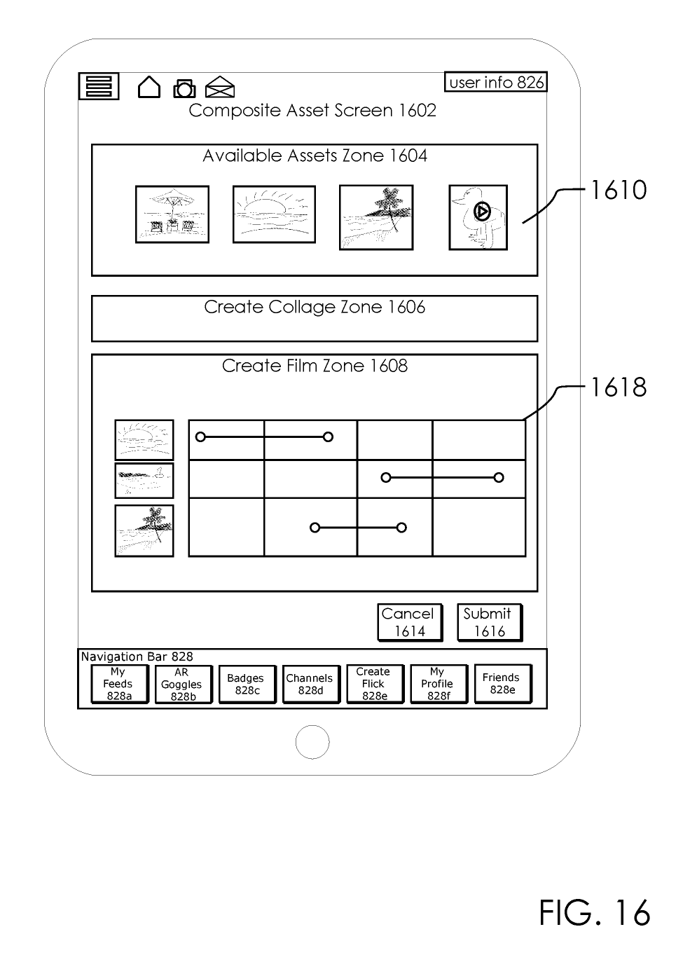

FIG. 16 illustrates an elevated overview view of a composite asset screen 1602.

In one embodiment, said composite asset screen 1602 can comprise said video timeline 1618.

In one embodiment, dragging one or more among said one or more assets 1610 into said create collage zone 1606 can allow users to edit and create a collage or collection of images, as is known in the art. One or more controls are omitted from this figure as technologies for creating collages are well-known in the art.

Likewise, in one embodiment, dragging one or more of said one or more assets into said create film zone 1608 can bring up a video editing tool, as is known in the art. For example, pressing said cancel button 1614 and-or said submit button 1616 can have well-known consequences.

In one embodiment, assets combined into new composite assets can inherit Meta data, such as location and authorship, from the component parts. In one embodiment, where all assets are verified as to authenticity coming into said composite asset screen 1602, the outgoing composite asset can comprise that same level of verification. Likewise, the assignment of channels, hubs, tags, or similar, can be done automatically.

In one embodiment, users can use said device application 502 to edit one or more assets on said composite asset screen 1602 before sharing them.

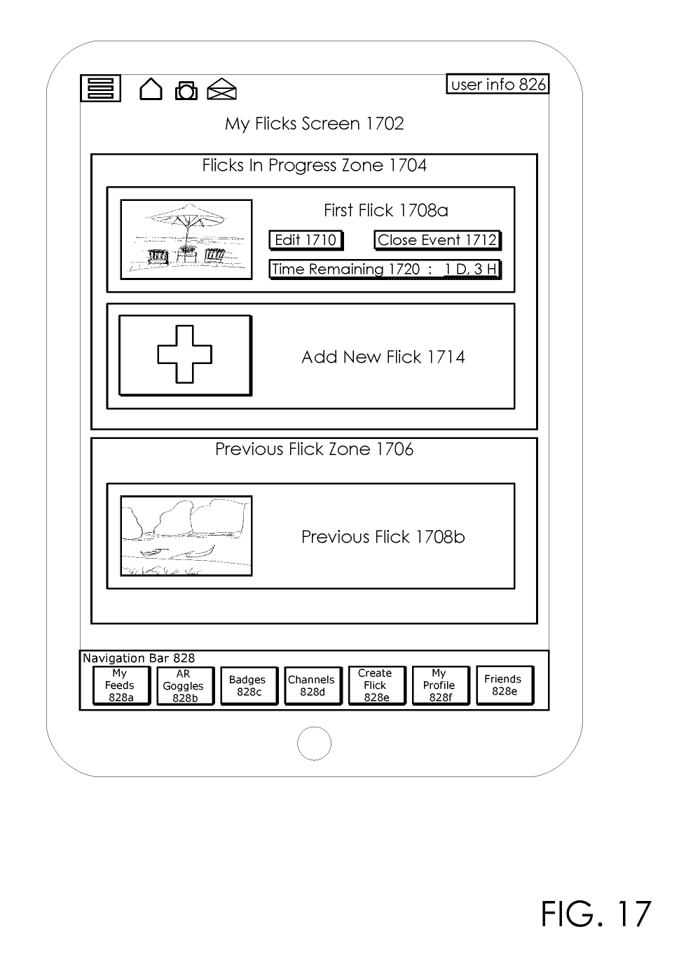

FIG. 17 illustrates an elevated overview view of a my flicks screen 1702.

In one embodiment, said one or more events can comprise an active status and an inactive status relevant to whether the individual event is closed for editing or not, or other conditions as would be known in the art.

In one embodiment, events in said flicks in progress zone 1704 can be closed and moved into said previous flicks zone 1706 by clicking on said close flick button 1712 or otherwise closing said event.

In one embodiment, said close flick button 1712 can close an event, and can be represented by a checkered flat icon.

In one embodiment, said one or more flicks in said flicks in progress zone 1704 can comprise said time remaining indicator 1720; wherein, said time remaining indicator 1720 counts down to zero when an event is automatically closed. For example, in one embodiment, said first flick 1708a comprises said time remaining indicator 1720 with one day and 3 hours remaining, as illustrated. At the conclusion thereof said first flick 1708a will be moved to said previous flicks zone 1706 automatically.

In one embodiment, said current user can open and edit an event by clicking on said edit button 1710, where said device application 502 will load a screen for the analysis and editing of assets related to that event.

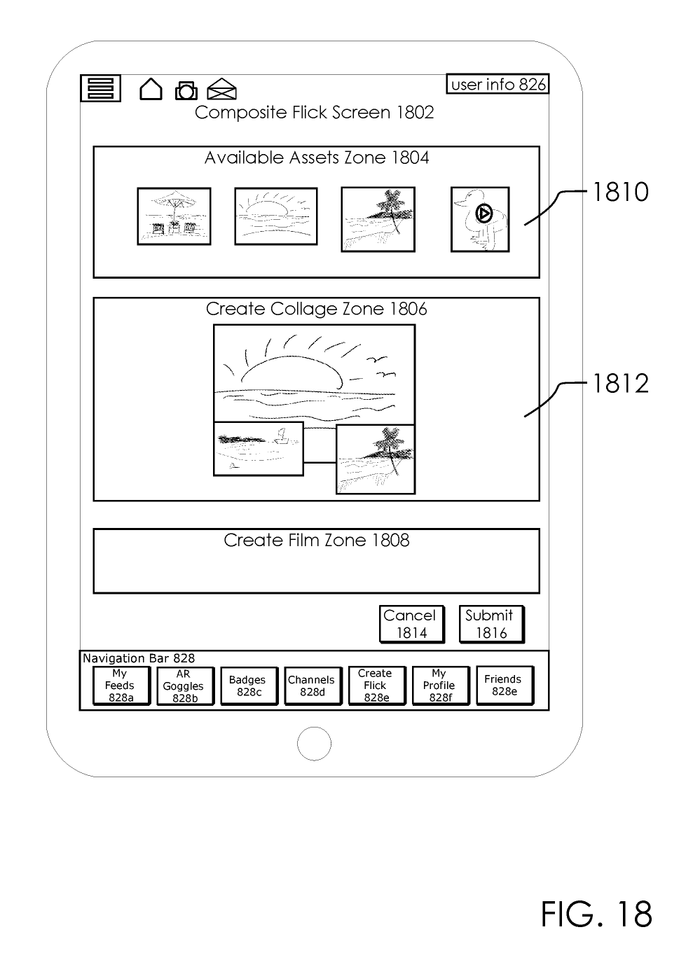

FIG. 18 illustrates an elevated overview view of a composite asset screen 1802.

In one embodiment, said composite asset screen 1802 can comprise said available assets zone 1804, said create collage zone 1806, said create film zone 1808, said one or more fresh assets 1810, said collage 1812, said cancel button 1814 and said submit button 1816.

In one embodiment, said available assets zone 1804 can comprise said one or more fresh assets 1810.

In one embodiment, said create collage zone 1806 can comprise said collage 1812.

In one embodiment, said available assets zone 1804 can be set to favor fresh assets such as those that were created in the previous 7 days. Accordingly, said software system 101 can create flicks with a more recent look and feel for other users.

Said available assets zone 1804, as stated, can be created from the last 7 days of assets created. This 7 day window can comprise a fresh assets collection. By limiting selections in said available assets zone 1804 to said fresh assets collection, the resulting flicks can be ensured of being recent and therefore more interesting to other users and sponsors. This limitation may also encourage a sense of urgency among users to create flicks quickly and therefore not forget to do so.

In one embodiment, said create film zone 1808 can rever to a traditional video file which has strictly defined frames and audio cues. In another embodiment, said create film zone 1808 can comprise a slideshow, an interactive piece of media, or other otherwise animate file type, as is known in the art.

In one embodiment, said one or more fresh assets 1810 can comprise assets created in the last 7 days. Limiting said available assets zone 1804 to said one or more fresh assets 1810, rather than an unlimited number of assets means that new flicks are limited to cover a relative new set of inputs, as discussed elsewhere herein.

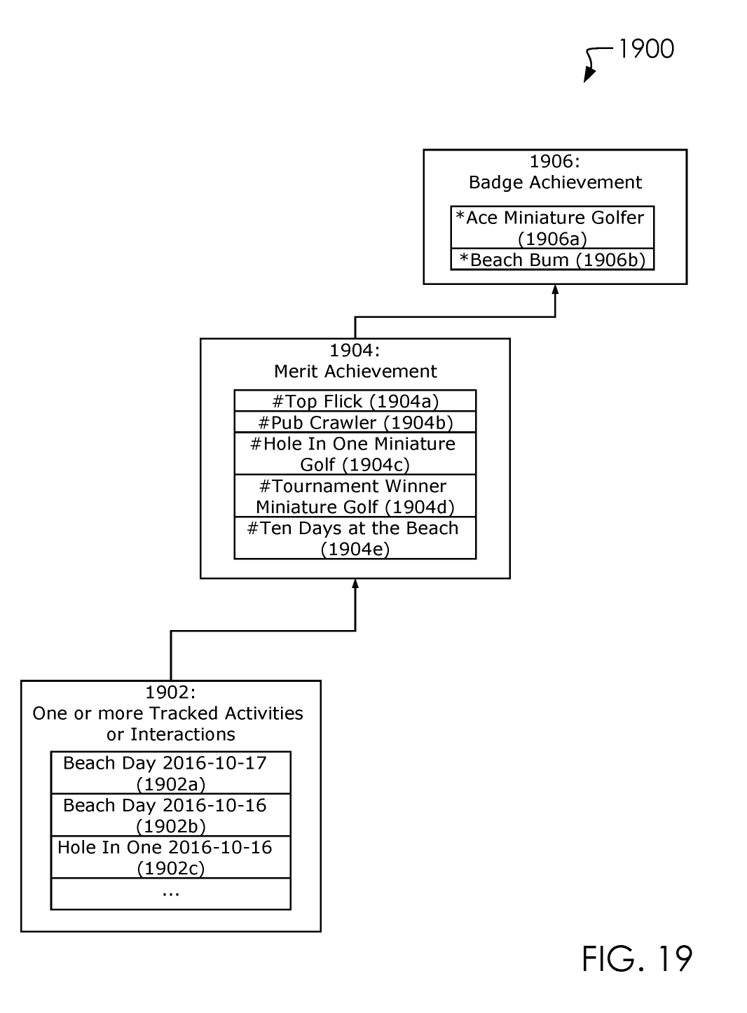

FIG. 19 illustrates a flow chart view of a categorizations hierarchy 1900.

In one embodiment, said categorizations hierarchy 1900 can comprise said one or more tracked activities or interactions 1902, said one or more merit achievements 1904 and said one or more badge achievements 1906.

In one embodiment, said one or more tracked activities or interactions 1902 can comprise said beach day activity 1902a, said beach day activity 1902b and said hole-in-one activity 1902c.

In one embodiment, said one or more merit achievements 1904 can comprise said top flick 1904a, said pub crawler 1904b, said hole-in-one miniature golf 1904c, said tournament winner miniature golf 1904d and said ten days at the beach 1904e.

In one embodiment, said one or more badge achievements 1906 can comprise said ace miniature golfer 1906a and said beach bum 1906b.

In one embodiment, said software system 101 can comprise said categorizations hierarchy 1900.

In one embodiment, said badges are made up of one or more merits and/or activities, and said merits are made up of one or more activities. Examples are given such as a user's earning a tournament win and a hole-in-one at miniature golf and therefore earning merits and a badge in honor of that achievement.

In one embodiment, there are some badges only available by joining a flick.

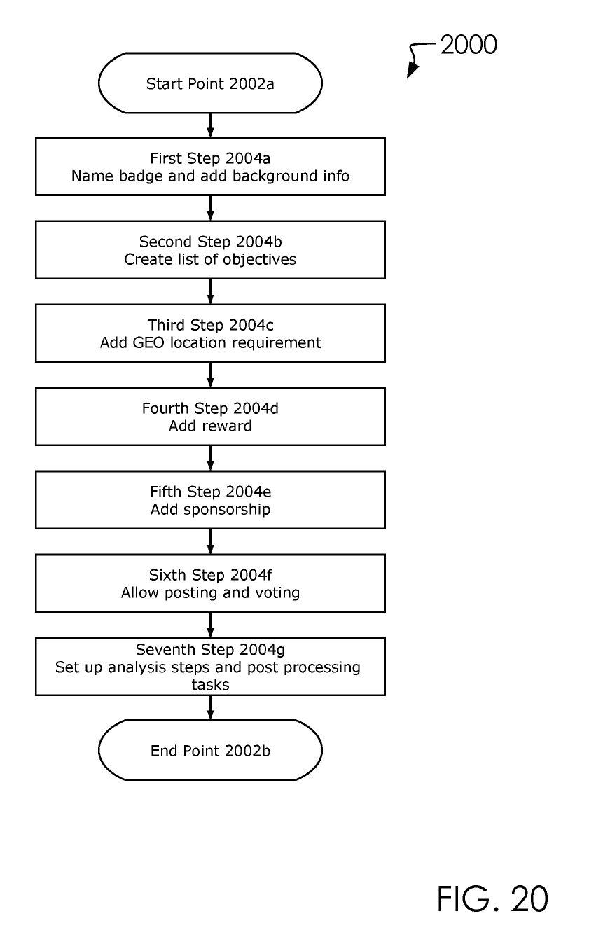

FIG. 20 illustrates a flow chart view of a badge creation process 2000.

In one embodiment, said badge creation process 2000 can comprise said start point 2002a, said end point 2002b, said first step 2004a, said second step 2004b, said third step 2004c, said fourth step 2004d, said fifth step 2004e, said sixth step 2004f and said seventh step 2004g.

In one embodiment, said first network configuration 100 can comprise said badge creation process 2000 and said badge creation process 2000.

Said first step 2004a can comprise naming a new badge and adding background information, such as location, start time, end time, or similar. Said second step 2004b can comprise creating a list of objectives such as merits, activities or similar for earning a badge. Examples can comprise going to points on a map, required tweets from one user to another, image capture requirements, AR grab with said AR goggles, a scratch off step such as illustrated in FIG. 11.

Said third step 2004c can comprise adding geo-location requirements to said new badge. For example, in one embodiment, requiring a VR/AR capture upon arriving at a location, using said AR goggles in that location, or similar.

Said fourth step 2004d can comprise adding a reward, discount or coupon for said new badge.

Said fifth step 2004e can comprise adding sponsorship associated with an advertising campaign.

Said sixth step 2004f can comprise allowing users to vote, post or otherwise promote a badge once earned.

Said seventh step 2004g can comprise setting up analysis steps and/or post processing tasks for a badge. Such wrap up tasks can comprise leader boards, event summaries, notifications of engagement, future badge notifications, or similar follow up settings.

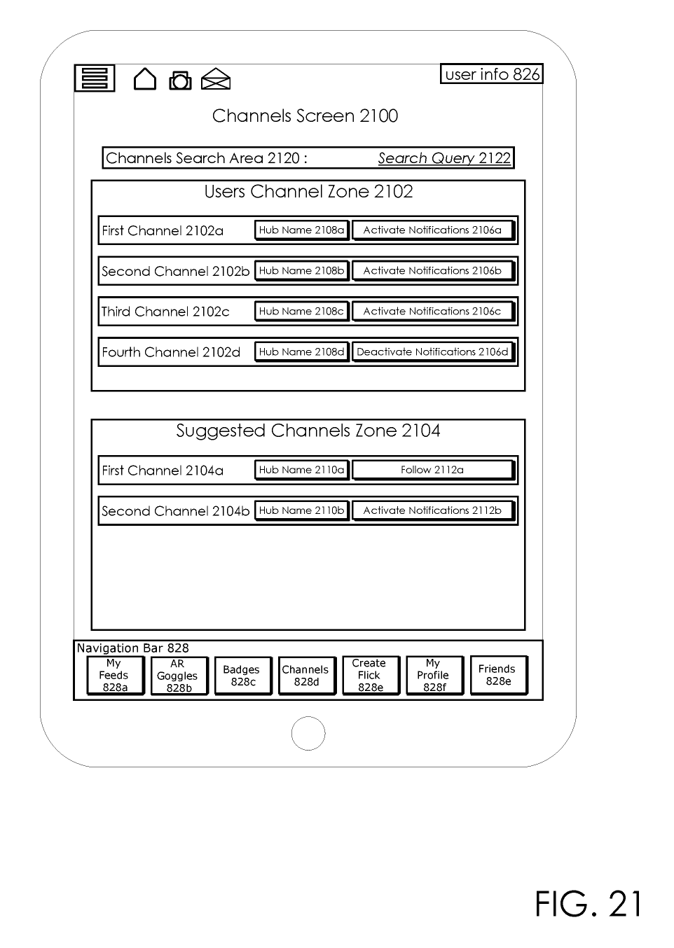

FIG. 21 illustrates an elevated overview view of a channels screen 2100.

In one embodiment, said channels screen 2100 can comprise said users channel zone 2102, said suggested channels zone 2104 and said channels search area 2120.

In one embodiment, said users channel zone 2102 can comprise said first channel 2102a, said second channel 2102b, said third channel 2102c and said fourth channel 2102d.

In one embodiment, said first channel 2102a can comprise said activate notifications 2106a and said hub name 2108a.

In one embodiment, said second channel 2102b can comprise said activate notifications 2106b and said hub name 2108b.

In one embodiment, said third channel 2102c can comprise said activate notifications 2106c and said hub name 2108c.

In one embodiment, said fourth channel 2102d can comprise said deactivate notifications 2106d and said hub name 2108d.

In one embodiment, said suggested channels zone 2104 can comprise said first channel 2104a and said second channel 2104b.

In one embodiment, said first channel 2104a can comprise said hub name 2110a and said follow button 2112a.

In one embodiment, said second channel 2104b can comprise said hub name 2110b and said follow button 2112b.

In one embodiment, said channels search area 2120 can comprise said search query 2122.

In one embodiment, said channels search area 2120 can be used to search records within said users channel zone 2102 and-or said suggested channels zone 2104.

In one embodiment, said users channel zone 2102 can comprise one or more channels being associated with said current user. In one embodiment, records in said users channel zone users channel zone 2102 can be set as receiving notifications or otherwise not receiving them according to the preferences of said current user. In one embodiment, said 2106a-2106d can be used to set a notification preference for said current user with regards to said users channel zone 2102. In one embodiment, said users channel zone 2102 can be associated with a one or more hubs which can comprise said 2106a-2106d.

In one embodiment, said suggested channels zone 2104 can recommend a one or more channels to said current user which have not yet been added to a user account of said current user.

In one embodiment, said current user can reach of a list of channels for other users with similar data to this for other users, as is known in the art.

In one embodiment, said suggested channels zone 2104 can be populated by said device application 502 according to a comparison of viewing habits of other users or other considerations, as is known in the art.

!!!

In one embodiment, said channels screen 1900 can be reached by clicking on said channels button 1310.

In one embodiment, said channels search area 1920 can be used to search records within said users channel zone 1902 and-or said suggested channels zone 1904a.

In one embodiment, said users channel zone 1902 can comprise one or more channels being associated with said current user 612. In one embodiment, records in said users channel zone users channel zone 1902 can be set as receiving notifications or otherwise not receiving them according to the preferences of said current user 612. In one embodiment, said 1906a-1906d can be used to set a notification preference for said current user 612 with regards to said users channel zone 1902. In one embodiment, said users channel zone 1902 can be associated with a one or more hubs which can comprise said 1906a-1906d.

In one embodiment, said suggested channels zone 1904a can recommend a one or more channels to said current user 612 which have not yet been added to a user account of said current user 612.

In one embodiment, said current user 612 can reach of a list of channels for other users with similar data to this for other users, as is known in the art.

In one embodiment, said suggested channels zone 1904a can be populated by said device application 502 according to a comparison of viewing habits of other users or other considerations, as is known in the art.

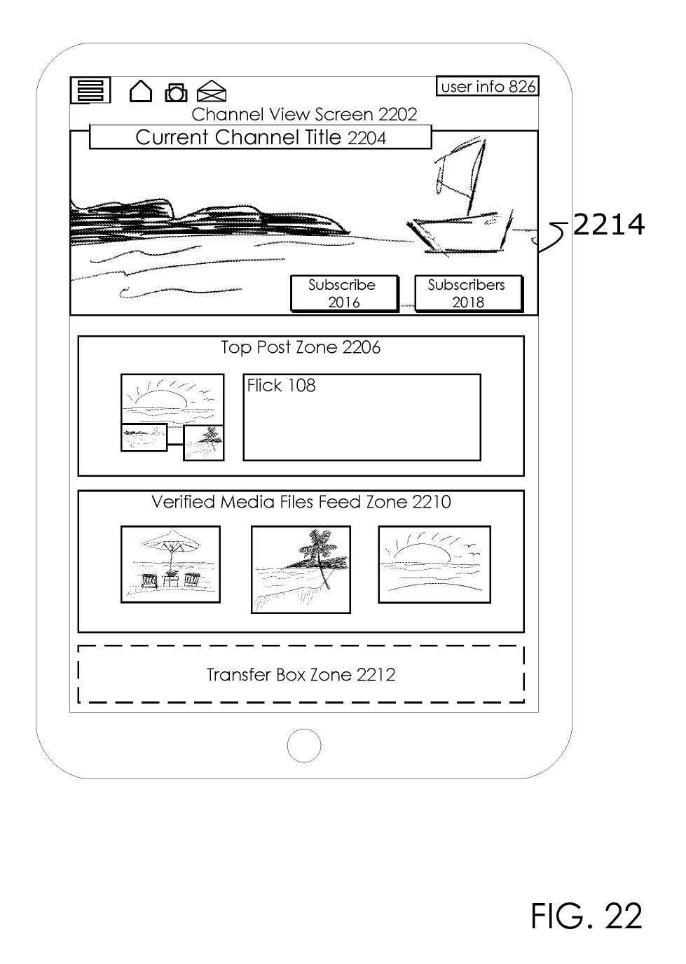

FIG. 22 illustrates an elevated overview view of a channel view screen 2202.

In one embodiment, said channel view screen 2202 can comprise said current channel title 2204, said top post zone 2206, said verified media files feed zone 2210 and said transfer box zone 2212.

In one embodiment, said current channel title 2204 can comprise said transfer box zone 2212, said subscribe button 2216 and said subscribers button 2218.

In one embodiment, said top post zone 2206 can comprise said flick post 2208.

In one embodiment, said flick editing screen 1502 can comprise said subscribers button 2218.

In one embodiment, clicking on a name of a channel on said users channel zone can bring a user to said channel view screen 2202 corresponding to that channel.

In one embodiment, said horizon image 2214 can comprise a top rated horizon associated with said current channel title 2204, which can be displayed as illustrated.

In one embodiment, said current user 612 can vote for and promote assets of said device application 502 by adding them to said transfer box zone 2212 and-or said library, as discussed to come.

In one embodiment, said verified media files feed zone 2210 can comprise a real time feed of assets associated with said current channel title 2204. In one embodiment, assets shown in said verified media files feed zone verified media files feed zone 2210 can be verified as to time, location and authorship so as to allow other users to verify the source of that content. In one embodiment, said verified media files feed zone 2210 can be configured to display a limited number of historical posts related to said current channel title 2204. In one embodiment, said verified media files feed zone 2210 can be limited to the three most recent verified posts related to said current channel title 2204.

In one embodiment, said subscribe button 2216 can be used to subscribe to said channel view screen 2202.

In one embodiment, said current user can view a list of the subscribers to said current channel title 2204 by clicking on said subscribers button 2218.

In one embodiment, said top post zone 2206 can display the top posts related to said current channel title 2204. In one embodiment, said top post zone top post zone 2206 can do so in chronological order.

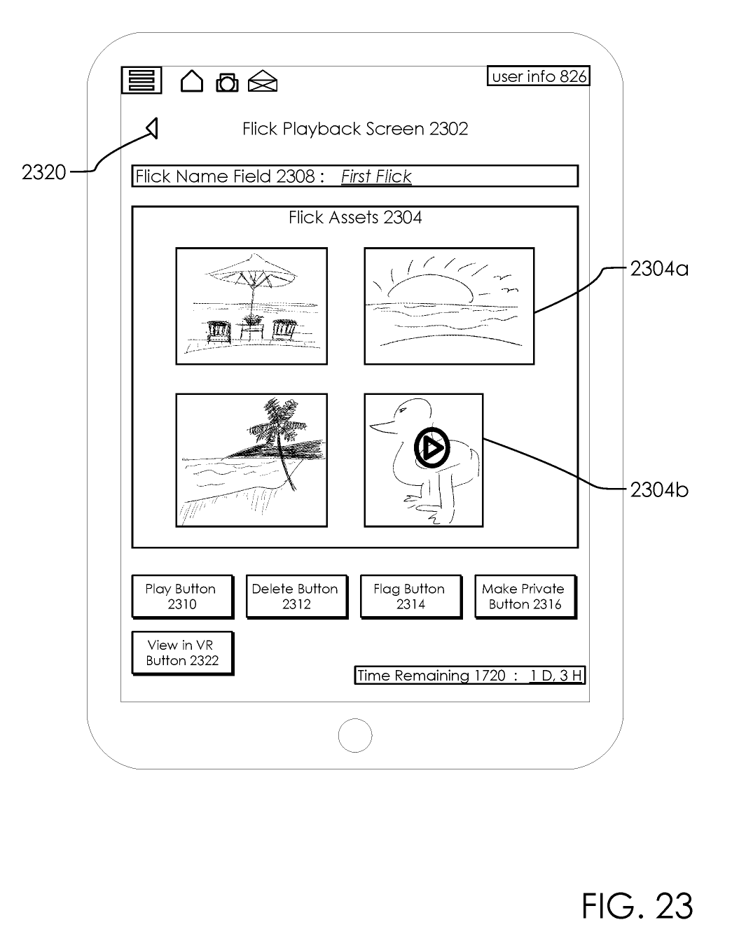

FIG. 23 illustrates an elevated overview view of a flick playback screen 2302.

In one embodiment, said flick playback screen 2302 can comprise said flick assets 2304, said flick name field 2308, said play button 2310, said delete button 2312, said flag button 2314, said make public 2316, said back button 2320 and said view in VR button 2322.

In one embodiment, said flick assets 2304 can comprise said first image 2304a and said first video 2304b.

In one embodiment, said flick playback screen 2302 can be used to playback or view parts of a flick, such as “First Flick” as demonstrated.

Said back button 2320 can be used on a portion of or on all screens of said software system 101, as is known in the art.

In one embodiment, said flick playback screen 2302 can be used by an author of a flick or a third party. Wherein, said third party may not have the option to delete (said delete button 2312) or make a flick private (said make public 2316). As illustrated, said flick playback screen 2302 can comprise a view for the owner or contributor of a certain flick.

In one embodiment, said view in VR button 2322 can allow a user to view a flick in VR. Where a flick does not include an asset strictly designed for VR, said device application 502 can present said flick assets 2304 in a VR setting through an automated generation of said VR, as is known in the art.

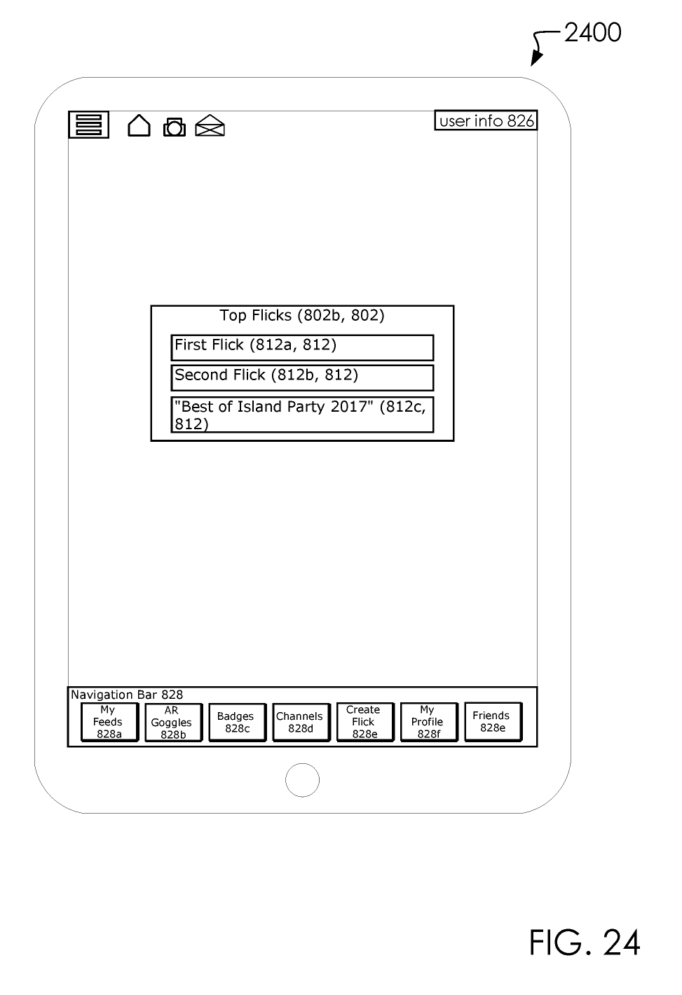

FIG. 24 illustrates an elevated overview view of a top flicks screen 2400.

In one embodiment, said software system 101 can comprise said top flicks screen 2400.

In one embodiment, said top flicks screen 2400 can show a one or more top flicks for an area, group of users, sponsors, or similar.

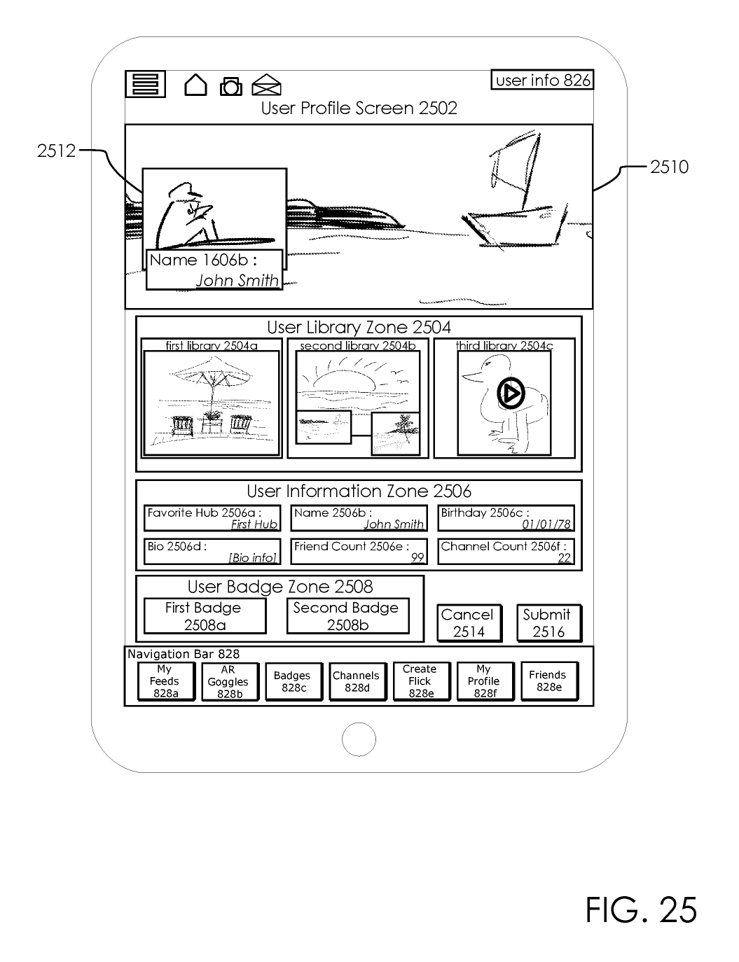

FIG. 25 illustrates an elevated overview view of an user profile screen 2502.

In one embodiment, said user profile screen 2502 can comprise said user library zone 2504, said user information zone 2506, said user badge zone 2508, said horizon image 2510, said profile image 2512, said cancel button 2514 and said submit button 2516.

In one embodiment, said user library zone 2504 can comprise said first library 2504a, said second library 2504b and said third library 2504c.

In one embodiment, said user information zone 2506 can comprise said favorite hub 2506a, said name 2506b, said birthday 2506c, said bio 2506d, said friend count 2506e and said channel count 2506f.

In one embodiment, said user badge zone 2508 can comprise said first badge 2508a and said second badge 2508b.

In one embodiment, said user profile screen 2502 can be reached by clicking on said profile button 716 from said navigation bar 708.

In one embodiment, said user profile screen 2502 can comprise a list of information and data being shared by said current user 612 to other persons. Access to said system menu 620 can be restricted to persons listed among the friends and-or connections of said current user 612, as is known in the art.

In one embodiment, said horizon image 2510 can extend across a top portion of said user profile screen 2502 and said profile image 2512 can be arranged on top of said horizon image 2510, as is known in the art.

In one embodiment, said user library zone 2504 can comprise assets from said device application 502, such as an image taken by said current user 612 (said first library 2504a), a collection of images (said second library 2504b), a video or slide show (such as said third library 2504c).

Said user information zone 2506 can comprise a collection of data about said current user 612, as is known in the art. In one embodiment, clicking on said user indication 720 and-or said name 2506b can allow said current user 612 to edit data displayed on said user profile screen 2502, as is known in the art.

In one embodiment, said user badge zone 2508 can be included on said user profile screen 2502. In one embodiment, said user badge zone user badge zone 2508 can comprise objectives having been accomplished, as is known in the art.

In one embodiment, said current user 612 can select one among said hubs by clicking said favorite hub 2506a and selecting a favorite among the choices. In one embodiment, however, said current user 612 cannot chose one of the hubs as a favorite without sending a friend request to the creator of that hub.

In one embodiment, clicking said cancel button 2514 and said submit button 2516 can comprise a well-known result after a user has edited portions of said user profile screen 2502, as is known in the art.

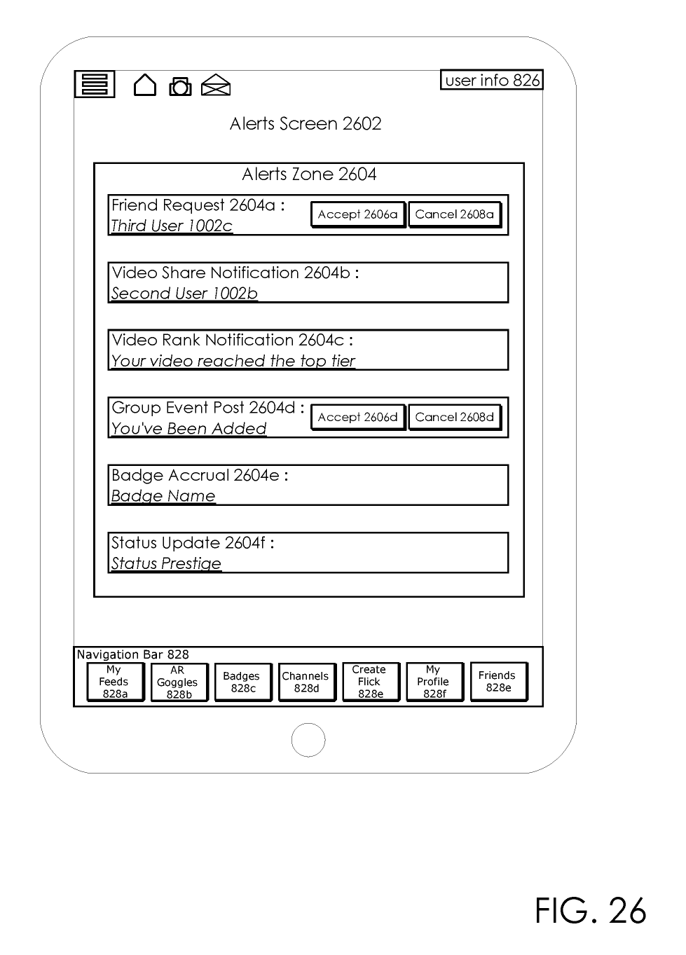

FIG. 26 illustrates an elevated overview view of an alerts screen 2602.

In one embodiment, said alerts screen 2602 can comprise said alerts zone 2604.

In one embodiment, said alerts zone 2604 can comprise said friend request 2604a, said video share notification 2604b, said video rank notification 2604c, said group flick post 2604d, said badge accrual 2604e and said status update 2604f.

In one embodiment, said friend request 2604a can comprise said accept button 2606a and said cancel button 2608a.

In one embodiment, said group flick post 2604d can comprise said accept button 2606d and said cancel button 2608d.

In one embodiment, said friend request 2604a can comprise an incoming friend request. Clicking on said accept button 2606a and said cancel button 2608a can be used to accept or decline said incoming friend request, as is known in the art.

In one embodiment, said video share notification 2604b can comprise a video having been created by said current user and shared.

In one embodiment, said video rank notification 2604c can comprise a notification from said device application 502 that one video from said current user has become a top ranked video.

In one embodiment, said group event post 2604d can comprise a notification that a user has added said current user to a group event post. Clicking on said cancel button 2606d and said cancel button 2608d can be used to accept or decline said group event post, as is known in the art.

In one embodiment, said badge accrual 2604e can comprise a notification that said current user has earned a new badge.

In one embodiment, said status update 2604f can comprise a status change notification for said current user.

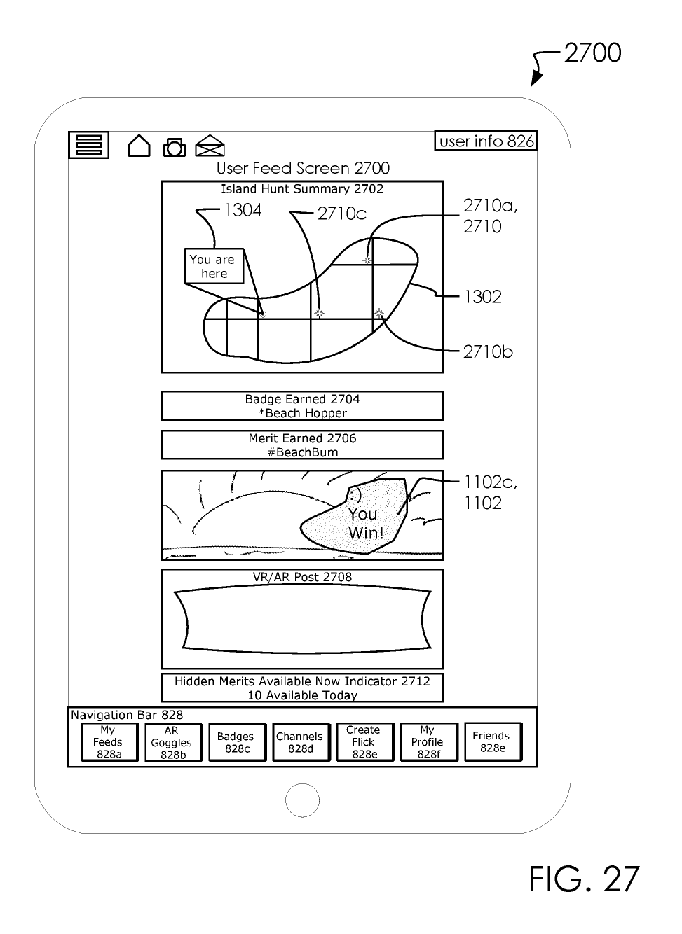

FIG. 27 illustrates an elevated overview view of an user feed screen 2700.

In one embodiment, said user feed screen 2700 can comprise said scavenger hunt summary 2702, said badge earned 2704, said merit earned 2706, said VR-AR post 2708, said VR-AR post 2708, said one or more goe-acheivements 2710 and said hidden merits available now indicator 2712.

In one embodiment, said one or more goe-acheivements 2710 can comprise said first goe-acheivement 2710a, said second goe-acheivement 2710b and said third goe-acheivement 2710c.

In one embodiment, said software system 101 can comprise said user feed screen 2700.

In one embodiment, said user feed screen 2700 can be rendered in a VR-AR viewer such as Google Cardboard. As well, other portions of said software system 101 can do the same.

In one embodiment, clicking on said VR-AR post 2708 can allow a user to launch a VR/AR file or feed.

In one embodiment, said hidden merits available now indicator 2712 can indicate how many merits are available in said user feed screen 2700 for a user willing to find said virtual object portion 1208 as hidden by other users with said add virtual object 1024 and/or said add virtual object option 906 (or similar).

Therefore, users can be encouraged to find and capture merits, badges or similar.

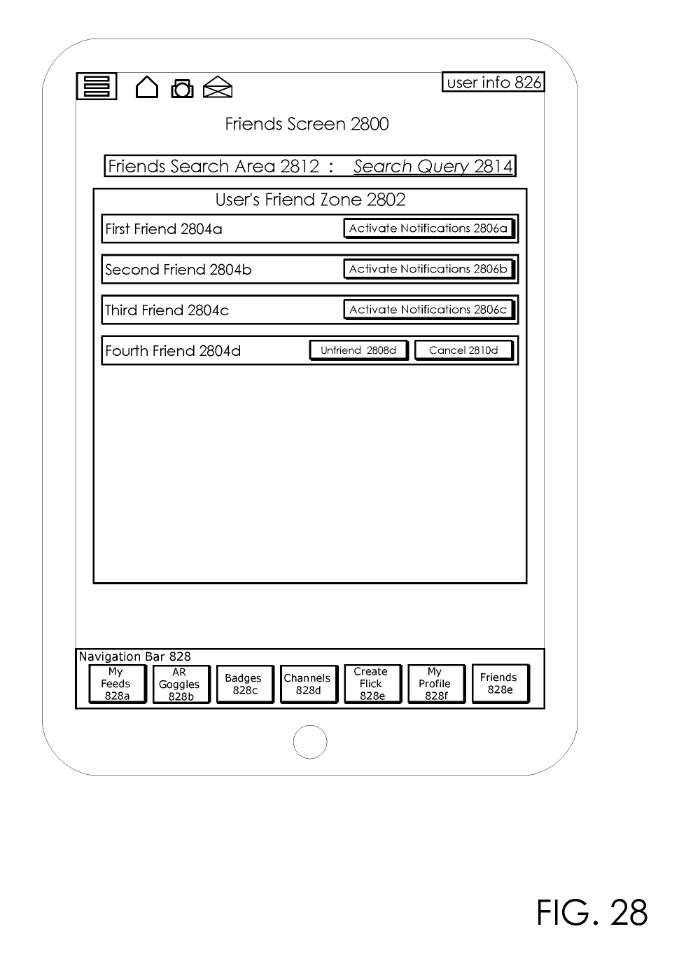

FIG. 28 illustrates an elevated overview view of a friends screen 2800.

In one embodiment, said friends screen 2800 can comprise said users friend zone 2802 and said friends search area 2812.

In one embodiment, said users friend zone 2802 can comprise said one or more friends 2804.

In one embodiment, said one or more friends 2804 can comprise said first friend 2804a, said second friend 2804b, said third friend 2804c, said fourth friend 2804d and said one or more activate notifications buttons 2806.

In one embodiment, said first friend 2804a can comprise said first activate notifications button 2806a, said first unfriend button 2808a and said first cancel button 2810a.

In one embodiment, said second friend 2804b can comprise said second activate notifications button 2806b, said second unfriend button 2808b and said second cancel button 2810b.

In one embodiment, said third friend 2804c can comprise said third activate notifications button 2806c and said third cancel button 2810c.

In one embodiment, said fourth friend 2804d can comprise said fourth activate notifications button 2806d, said fourth unfriend button 2808d and said fourth cancel button 2810d.

In one embodiment, said one or more activate notifications buttons 2806 can comprise said first activate notifications button 2806a, said second activate notifications button 2806b, said third activate notifications button 2806c and said fourth activate notifications button 2806d.

In one embodiment, said one or more unfriend buttons 2808 can comprise said first unfriend button 2808a, said second unfriend button 2808b, said third unfriend button 2808c and said fourth unfriend button 2808d.

In one embodiment, said one or more cancel buttons 2810 can comprise said first cancel button 2810a, said second cancel button 2810b, said third cancel button 2810c and said fourth cancel button 2810d.

In one embodiment, said friends search area 2812 can comprise said search query 2814.

In one embodiment, said software system 101 can comprise said friends screen 2800, said users friend zone 2802, said users friend zone 2802, said fourth friend 2804d, said fourth activate notifications button 2806d, said fourth unfriend button 2808d, said friends search area 2812 and said search query 2814.

In one embodiment, user's friend zone 2802 can comprise a list of users identified as friends or connections with said current user.

Said one or more friends 2804 can each comprise and activate notifications button (said first friend 2804a with said activate notifications button 2806a, said second friend 2804b with said 2806b, and said third friend 2804c with said activate notifications button 2806c). Likewise, said one or more friends 2804 can have an unfriend button 2808d and a cancel button 2810d.

In one embodiment, said friends screen 2800 can comprise said friends search area 2812 for searching among said one or more friends 2804.

Likewise, said user's friend zone 2802 can be shown to other users on said device application 502 and said current user can access this list as associated with another user among his connections, as is known in the art.

!!!

In one embodiment, said alerts screen 1702 can be arrived at by clicking on said alerts button 1306 in said system menu 620.

In one embodiment, said friend request 1704a can comprise an incoming friend request. Clicking on said accept button 1706a and said cancel button 1708a can be used to accept or decline said incoming friend request, as is known in the art.

In one embodiment, said video share notification 1704b can comprise a video having been created by said current user 612 and shared.

In one embodiment, said video rank notification 1704c can comprise a notification from said device application 502 that one video from said current user 612 has become a top ranked video.

In one embodiment, said group event post 1704d can comprise a notification that a user has added said current user 612 to a group event post. Clicking on said cancel button 1706d and said 1708d/can be used to accept or decline said group event post, as is known in the art.

In one embodiment, said badge accrual 1704e can comprise a notification that said current user 612 has earned a new badge.

In one embodiment, said status update 1704f can comprise a status change notification for said current user 612.

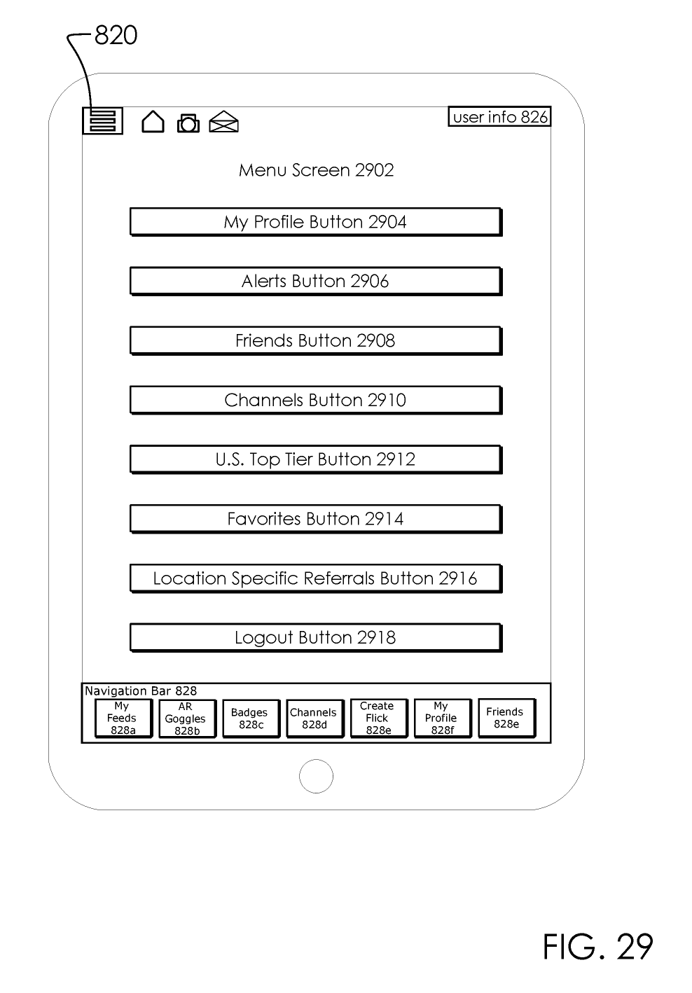

FIG. 29 illustrates an elevated overview view of a menu screen 2902.

In one embodiment, said menu screen 2902 can comprise said my profile button 2904, said alerts button 2906, said friends button 2908, said channels button 2910, said U.S. top tier button 2912 and said logout button 2914.

In one embodiment, clicking on said system menu 820 can bring up said menu screen 2902 with menu items related management of said device application 502. Buttons on this screen can have familiar uses for said device application 502, as is known in the art.

In one embodiment, said U.S. top tier button 2912 can bring up a list of the top assets as voted by all users in a country to which said current user 612 is associated, in this case the United States. In one embodiment, said logout button 2918 can log out said current user 612. Said my profile button 2904a will be discussed below.

In one embodiment, said favorites button 2914 can comprise a list of a favorite set of channels, event posts, or assets which may be of use to said current user 612.

Said location specific referrals button 2916 can comprise a list of recommendations based upon the location of said current user 612. The location of said current user 612 can be determined by network location, GPS, questionnaire, or similar, as is known in the art.

Said logout button 2918 can enable said current user 612 to log out of said device application 502.

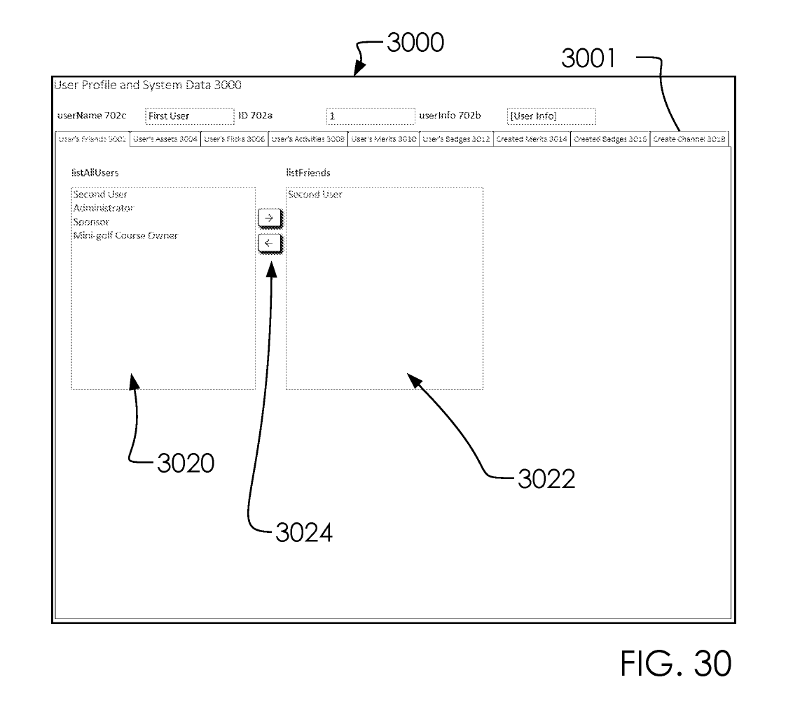

FIG. 30 illustrates GUI view of an user profile and system data screen 3000.

In one embodiment, said user profile and system data screen 3000 can comprise said tab group 3001 and said user's friends tab 3002.

In one embodiment, said tab group 3001 can comprise said user's friends tab 3002, said user's assets tab 3004, said user's flicks tab 3006, said user's activities tab 3008, said user's merits tab 3010, said user's badges tab 3012, said created badges tab 3014, said created badges tab 3016 and said create channel tab 3018.

In one embodiment, said user's friends tab 3002 can comprise said users list 3020, said friends list 3022 and said add-remove buttons 3024.

In one embodiment, said software system 101 can comprise said user profile and system data screen 3000.

In one embodiment, said user profile and system data screen 3000 can comprise a data entry and/or administrator view of said software system 101; wherein, said database tables 700 are expressed in a useful manner for discussion.

In one embodiment, said users list 3020 can comprise a list of users in said software system 101 (specifically in said tblUsers 702). Entries in said users list 3020 can be selected and added to said friends list 3022 by pressing said add-remove buttons 3024, as is known in the art.

Each relationship between one user and another can be recorded in said tblCRTUserConnections 728.

User relationships can be useful in filling up feeds, flicks and current activities for one user or another in said software system 101.

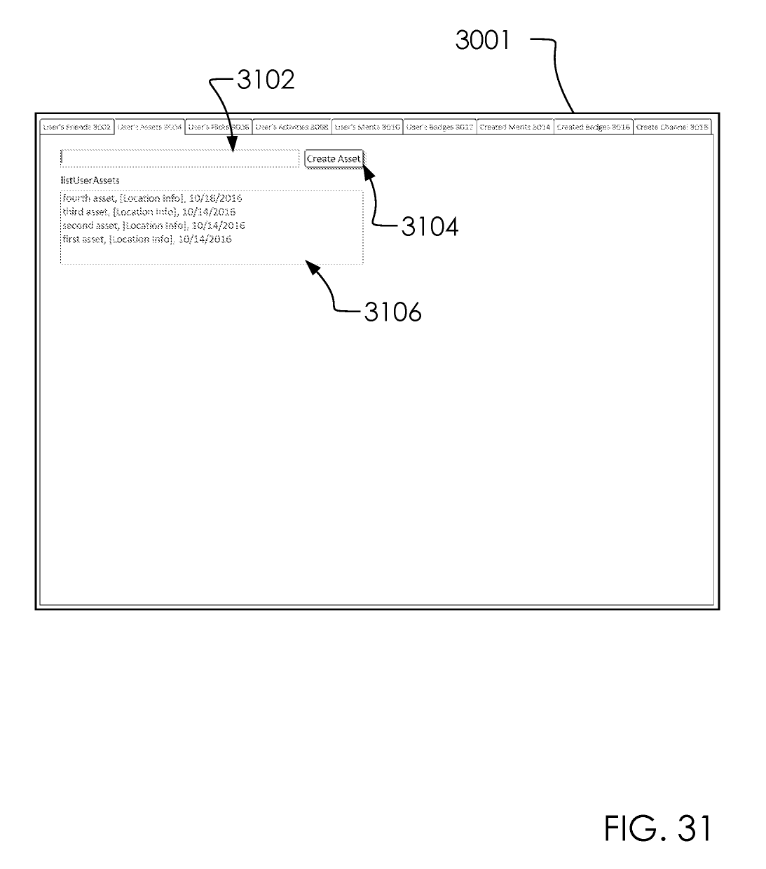

FIG. 31 illustrates a GUI view of an user's assets tab 3004.

In one embodiment, said user's assets tab 3004 can comprise said create asset blank 3102, said create asset button 3104 and said user assets list 3106.

In one embodiment, a user can create an asset using said asset capture process 900, said new asset dialog 1002, and/or said capture button 822, as illustrated and discussed above.

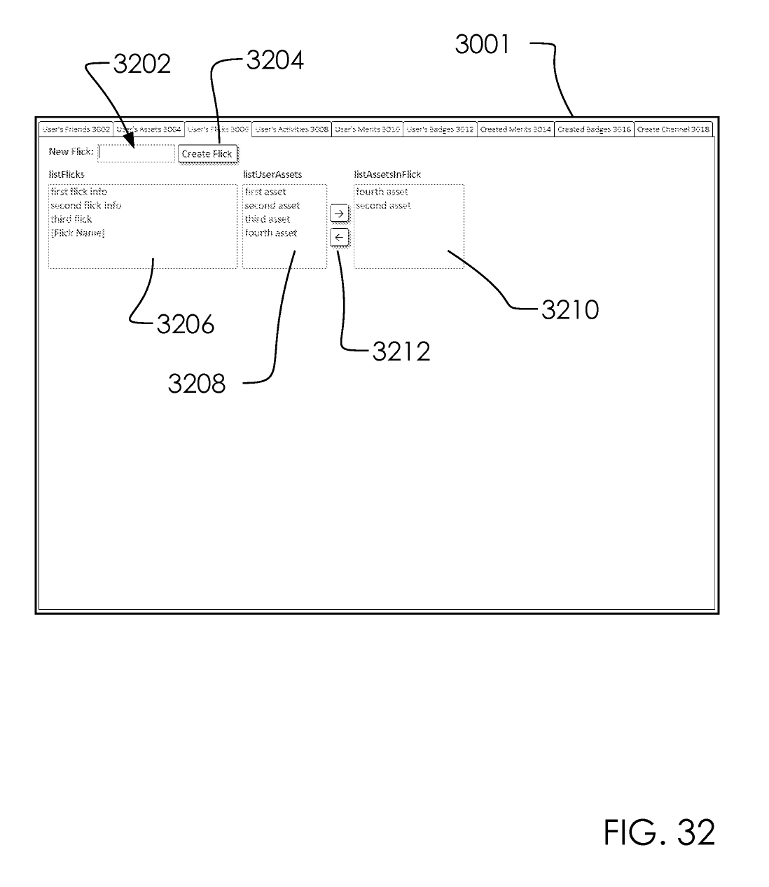

FIG. 32 illustrates a GUI view of an user's flicks tab 3006.

In one embodiment, said user's flicks tab 3006 can comprise said new flick blank 3202, said create flick button 3204, said flick list 3206, said user assets list 3208, said assets in flick list 3210 and said add-remove buttons 3212.

Said user's flicks tab 3006 can comprise a list of flicks created by the current user or a menu for creating new flicks.

In one embodiment, a flick can comprise one or more assets combined into a new creative work. For example, in one embodiment, said new flick blank 3202 and said create flick button 3204 can be used to create a new flick which can be added to said flick list 3206. In one embodiment, said flick list 3206 can comprise a list of flicks owned by a current user. In one embodiment, said user assets list 3208 can comprise a one or more assets which can be added to a new or existing item in said flick list 3206. In one embodiment, said assets in flick list 3210 can comprise a list of assets already added to an item selected in said flick list 3206. In one embodiment, said add-remove buttons 3212 can be used for removing and/or adding items into said assets in flick list 3210.

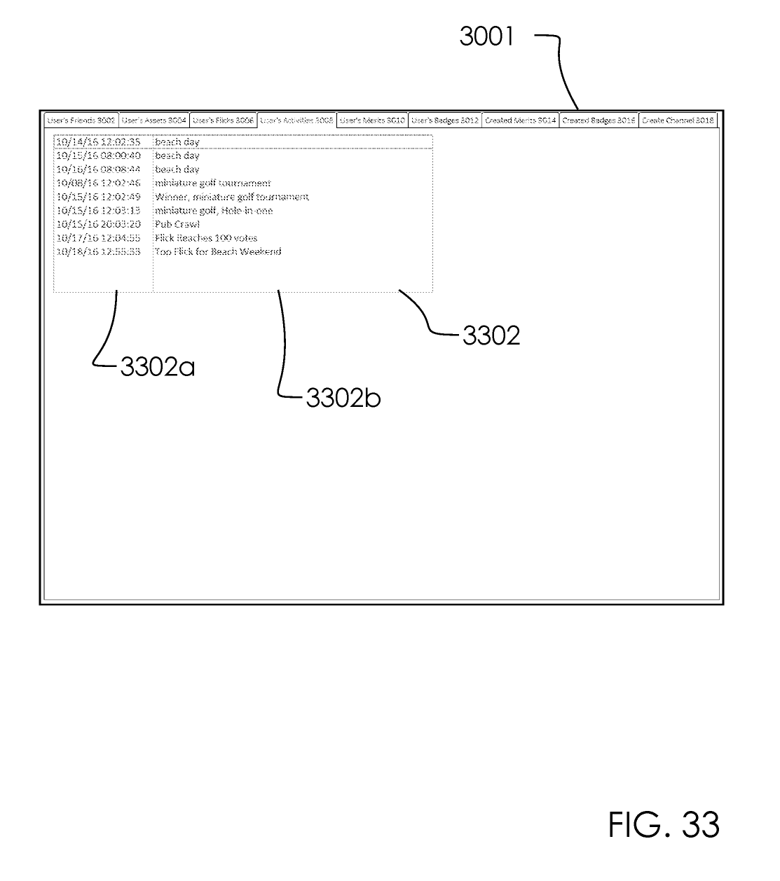

FIG. 33 illustrates a GUI view of an user's activities tab 3008.

In one embodiment, said activities list 3302 can comprise said date-time column 3302a and said description column 3302b.

In one embodiment, said user's activities tab 3008 can comprise said activities list 3302.

In one embodiment, said user's activities tab 3008 can comprise a list of and/or a graphical display of a one or more historical activates involving a current user. For example, as illustrated, a first user has been to the beach three days I a row, won a miniature golf tournament, gone on a pub crawl and won a few lauds from said software system 101 concerning his flicks. This list of activities can be generated through platform activities (such as logging into a tournament, attending a beach which is verified through GPS, or similar).

Said activities list 3302 can comprise a first part for reading out a time or other biological data (said date-time column 3302a) and a second part for displaying a description of an entry (such as said description column 3302b).

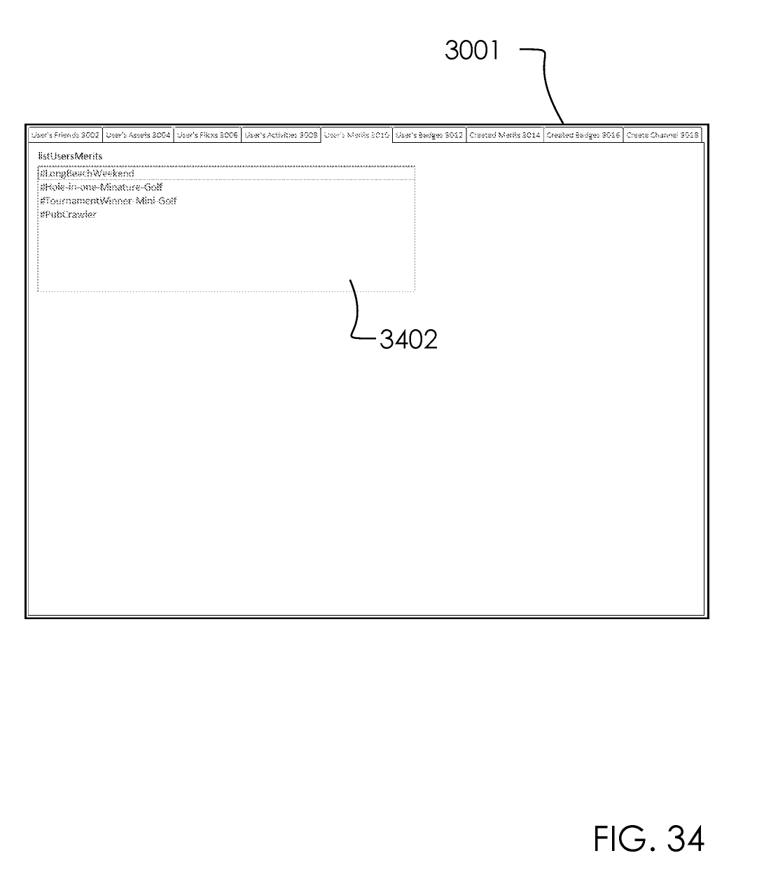

FIG. 34 illustrates a GUI view of a new asset dialog 3402.

In one embodiment, said new asset dialog 3402 can comprise a list of earned merits by a current user. Here, this list is preceded by a hashtag for indicating an earned event for that user. Other special characters can be used to call up merits, badges, activities, or similar.

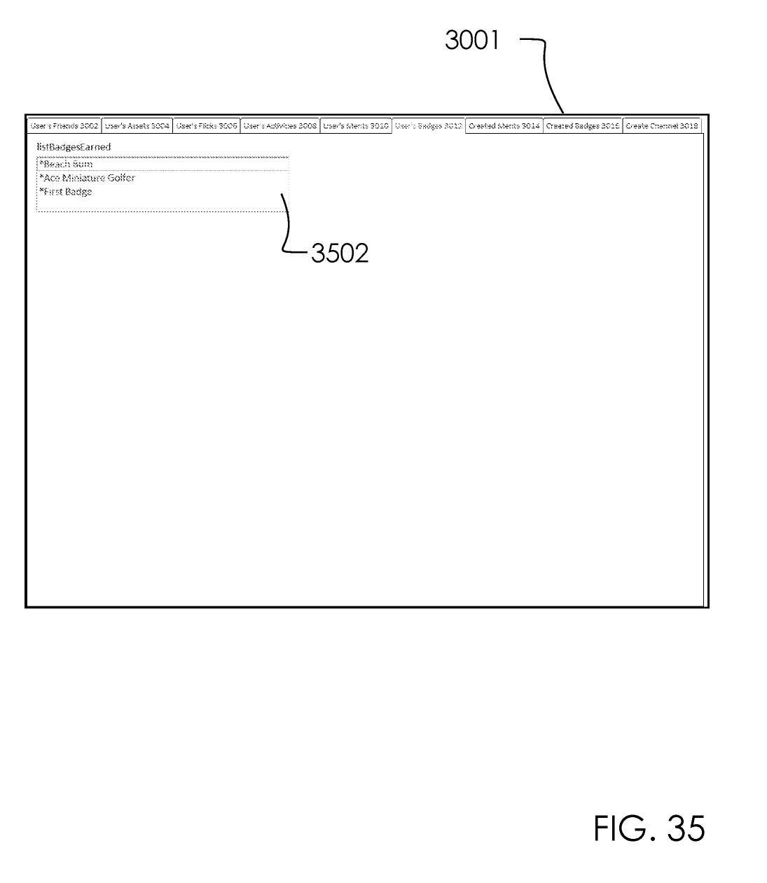

FIG. 35 illustrates a GUI view of an add new flick screen 3502.

In one embodiment, said user's badges tab 3012 can comprise a list of badges earned by a current user. Each badge can serve to indicate a high level of activity on a system. In one embodiment, said badges can be collected and stored for later bragging rights or other social capital.

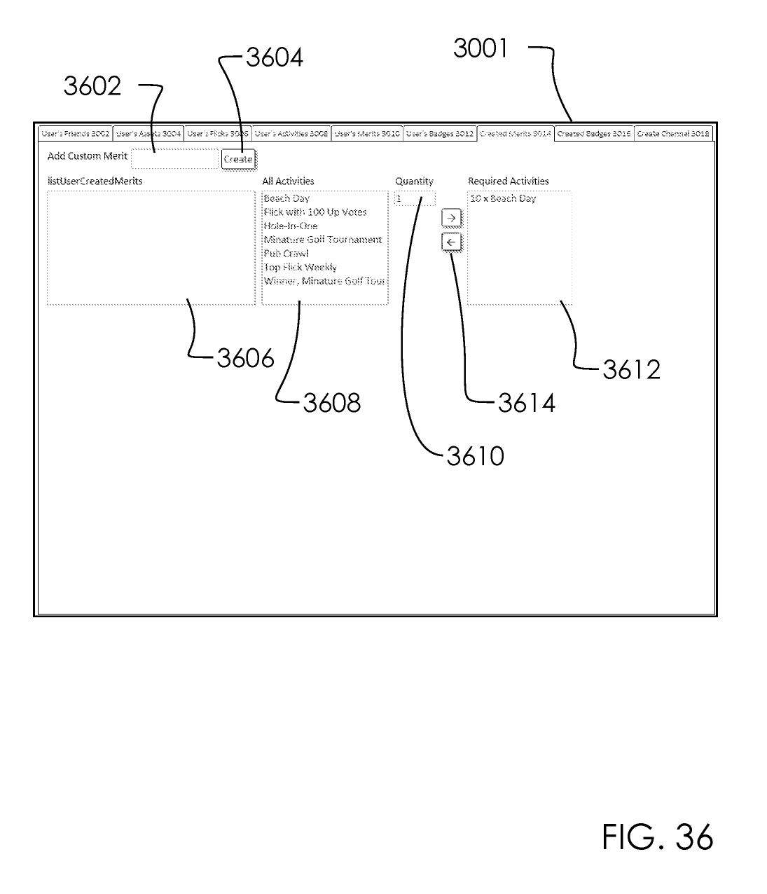

FIG. 36 illustrates a GUI view of a created badges tab 3014.

In one embodiment, said created badges tab 3014 can comprise said add custom merit blank 3602, said create merit button 3604, said created merits list 3606, said all activates list 3608, said quantity blank 3610, said required activates list 3612 and said add-remove button 3614.

In one embodiment, said created badges tab 3014 can comprise a list of merits which can be added to with said 3welcome screen 602 and said 3my feed 604. In one embodiment, new merits can be added to said 3capture asset 606. In one embodiment, each merit can comprise one or more activities, such as those illustrate din said 3AR goggles 608. In one embodiment, said created badges tab 3014 can comprise said 3current flicks 612 which represent requirements for earning a merit. For example, in one embodiment, said beach bum might require 10 days at the beach. To this point, said 3geo-messages 610 can comprise a number of activities required for acquiring a merit, as illustrated. In one embodiment, said 3badges 614 can add or remove activates from a merit.

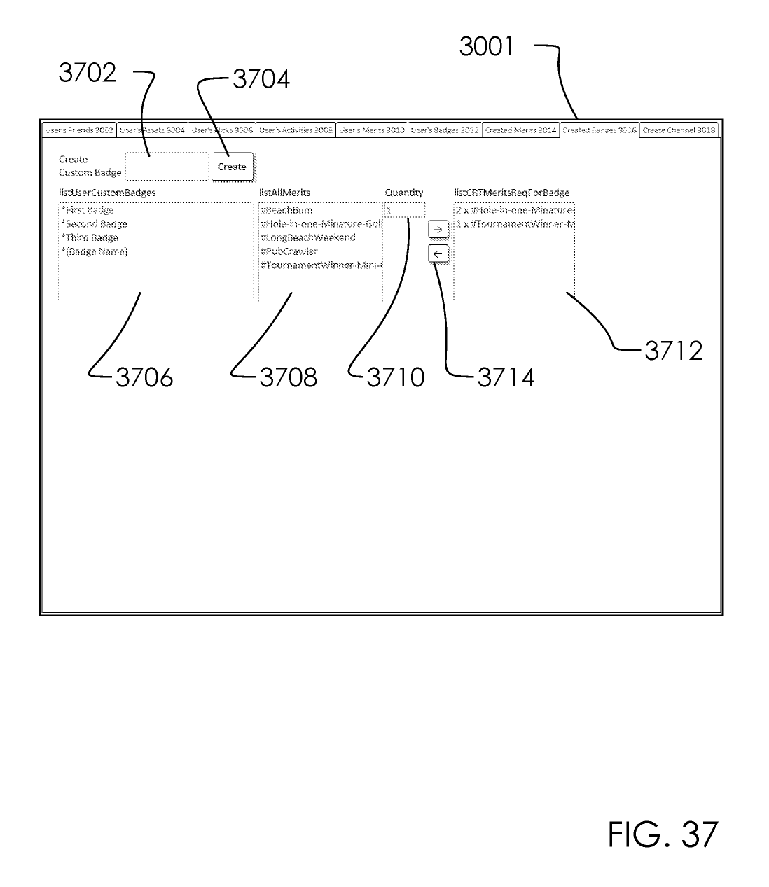

FIG. 37 illustrates a GUI view of a created badges tab 3016.

In one embodiment, said created badges tab 3016 can comprise said create badge blank 3702, said create badge button 3704, said badges list 3706, said merits list 3708, said quantity blank 3710, said merits required list 3712 and said add-remove buttons 3714.

In one embodiment, said 3tblUsers 702 and said 3tblAssets 704 are used to add new items to said 3tblFlicks 706.

In one embodiment, said 3tblFlicks 706 can be a list of badges created by a current user.

In one embodiment, said 3tblCRTAssetsInFlicks 708 can comprise a list of merits for use in creating formulas for earning a badge from said 3tblFlicks 706.

In one embodiment, a user of said created badges tab 3016 can select an item in said 3tblFlicks 706, an item in said 3tblCRTAssetsInFlicks 708, enter a number required in said 37120, and press an add button among said 3tblmerits 714; whereby, a requirement for earning a badge in said 3tblFlicks 706 can be added to said 3tblCRTBadgesEarneds 712.

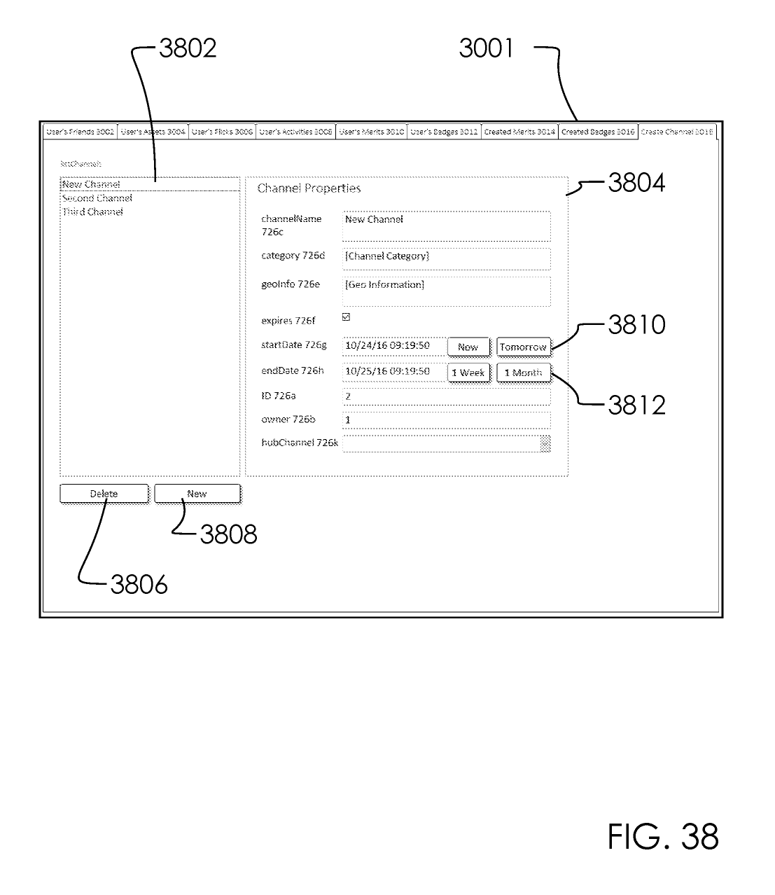

FIG. 38 illustrates a GUI view of a create channel tab 3018.

In one embodiment, said channel properties window 3804 can comprise said set start date buttons 3810 and said set end date buttons 3812.

In one embodiment, said create channel tab 3018 can comprise said channels list 3802, said channel properties window 3804, said delete channel button 3806, said new channel button 3808, said set start date buttons 3810 and said set end date buttons 3812.

In one embodiment, said create channel tab 3018 can comprise said channels list 3802 for displaying a list of channels created by a current user. By selecting one among said channels list 3802, said channel properties window 3804 can be loaded with information about the selected channel.

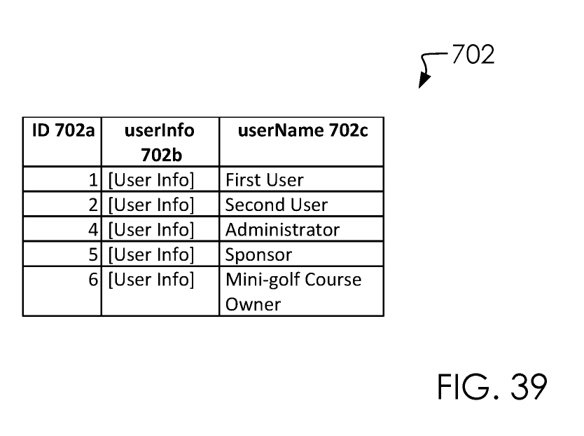

FIG. 39 illustrates data table view of a tblUsers 702.

In one embodiment, said ID 702a can comprise a unique identifier, said userInfo 702b can comprise a one or more data signals for each user in said tblUsers 702. Said userName 702c can comprise a user name, actual name, or nick name for each user in said tblUsers 702, as is known in the art.

The data populating said database tables 700 can just be an example of data being used by said device application 502 and which may be vaster and may be scaled up differently than illustrated, as is known in the art.

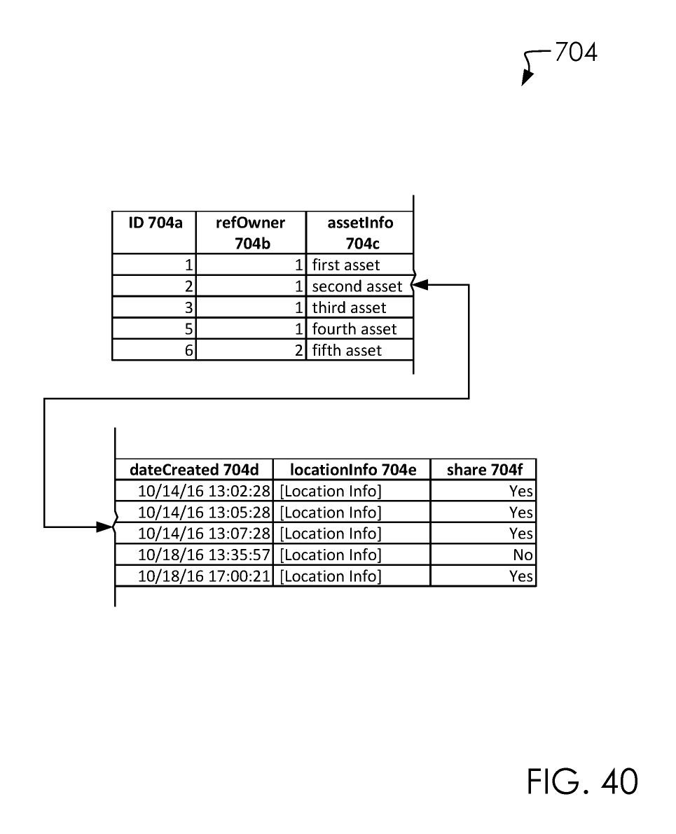

FIG. 40 illustrates data table view of a tblAssets 704.

In one embodiment, said ID 704a can comprise a unique identifier; said refOwner 704b can comprise a reference to a record in said tblUsers 702, said assetInfo 704c can comprise a name for an asset; said dateCreated 704d can comprise a date created; said locationInfo 704e can comprise a location or geographical information about a record; and said share 704f can be used to indicate a level of privacy for a new asset, as is known in the art.

In one embodiment, said tblAssets 704 can comprise can comprise images, videos, or composite assets, as discussed above. For example the record labeled as “First Composite Asset” in said description 2106f, can comprise a collection of images on a theme, such as images taken while in Galveston, Tex.

In one embodiment, those assets labeled by a user into a channel (said asset table 2106) can be shared broadly into that channel page.

In one embodiment, said channels xref 2106k may not be included in this table, as more than one channel may be associated with an asset. For example, an asset may be initially created and associated with a local channel but later become more famous so as to elevate or prestige up through regions to gain a national following. Accordingly, a separate table might be helpful in describing these relationships between channels and assets.

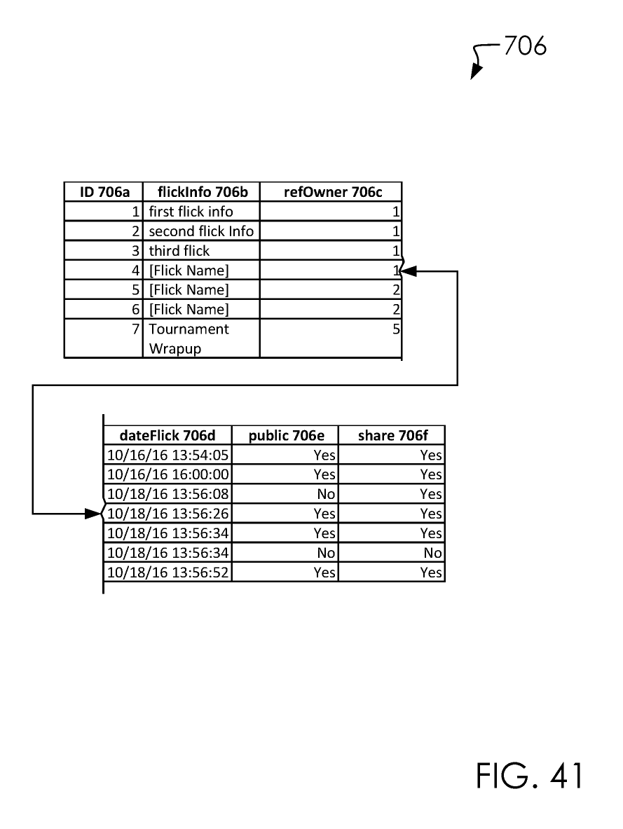

FIG. 41 illustrates data table view of a tblFlicks 706.

Said ID 706a can comprise a unique identifier for records in said tblFlicks 706; said flickInfo 706b can comprise a reference to a record in said tblUsers 702; said dateFlick 706d can comprise a date of a flick; said 706e/can comprise a flag for public use of said a flick; said share 706f can comprise a flag as to whether a flick has been shared by the original user. In one embodiment, where said 706e/is false, a flick might be considered a story since it is private.

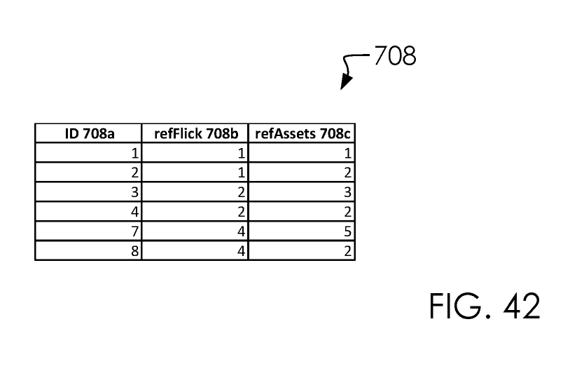

FIG. 42 illustrates data table view of a tblCRTAssetsInFlicks 708.

In one embodiment, said tblCRTAssetsInFlicks 708 can comprise a cross reference table between items in said tblFlicks 706 and said tblAssets 704. Said ID 708a can comprise a unique identifier; said refFlick 708b can comprise a flick reference; and said refAssets 708c can comprise an asset reference.

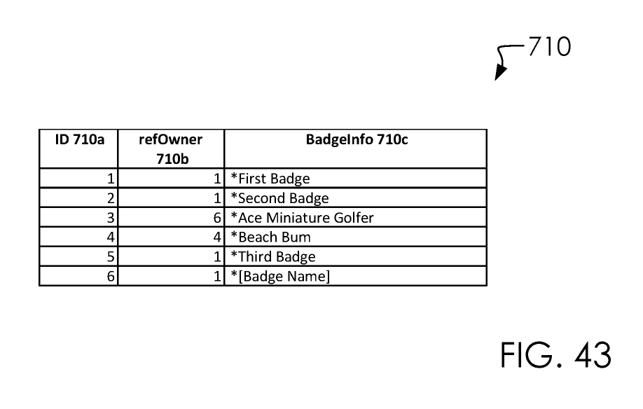

FIG. 43 illustrates data table view of a tbleBadges 710.

In one embodiment, said tbleBadges 710 can comprise a list of badges wherein: said ID 710a can comprise a unique identifier; said refOwner 710b can comprise a reference to a record in said tblUsers 702; and said BadgeInfo 710c can comprise a name for a badge.

In one embodiment, a user of said device application 502 can desire to gain prestige within said device application 502. Wherein, the collection of badges and accomplishments within the system may be tied to the score or reputation of a user.

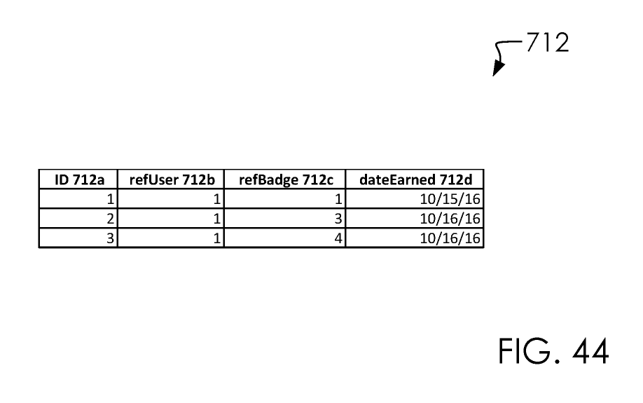

FIG. 44 illustrates data table view of a tblCRTBadgesEameds 712.

said tblCRTBadgesEameds 712 can comprise a list of users and the badges which they have earned. For example, as illustrated, user ID 1 comprises three badges with unique identifiers 1, 3 and 4.

In one embodiment, said ID 712a can comprise a unique identifier; said tblCRTBadgesEarneds 712 can comprise a reference to a user in said tblUsers 702; said refBadge 712c can comprise a reference to a record in said tbleBadges 710; and said dateEarned 712d can comprise a date corresponding to a date of collecting a badge.

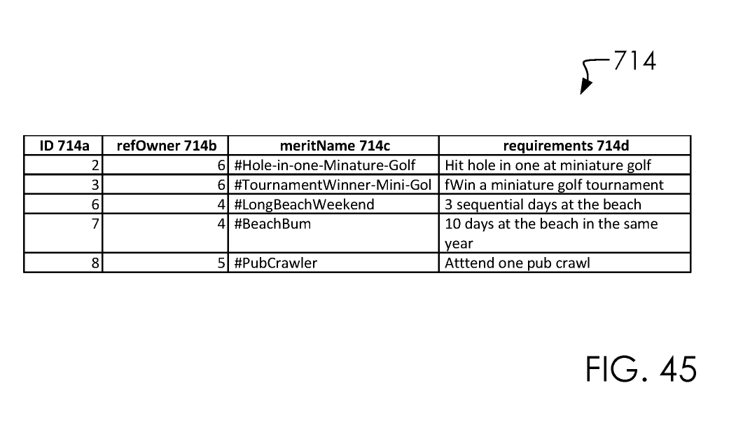

FIG. 45 illustrates data table view of a tblmerits 714.

In one embodiment, said tblmerits 714 can comprise a list of merits and requirements for collecting. Said ID 714a can comprise a unique identifier; said refOwner 714b can comprise a reference to a user in said tblUsers 702; said meritName 714c can comprise a name for a merit; and said requirements 714d can comprise a requirement summary for earning said merit.

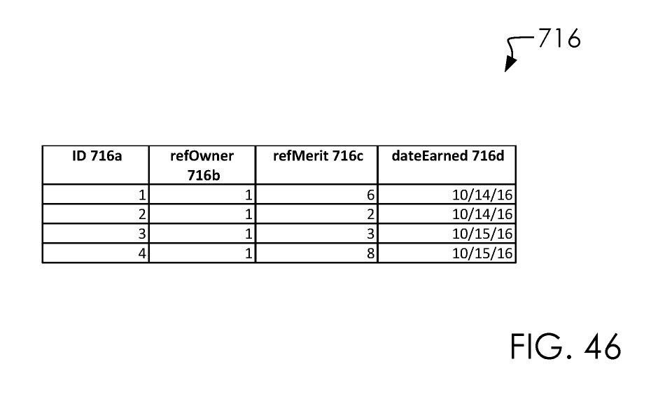

FIG. 46 illustrates data table view of a tblCRTmeritEarneds 716.

In one embodiment, said tblCRTmeritEarneds 716 can comprise a list of merits earned by each user. Said ID 716a can comprise unique identifier; said refOwner 716b can comprise a reference to an owner of the merit; said refmerit 716c is a reference to the merit having been earned; and said dateEarned 716d is the date of earning the merit.

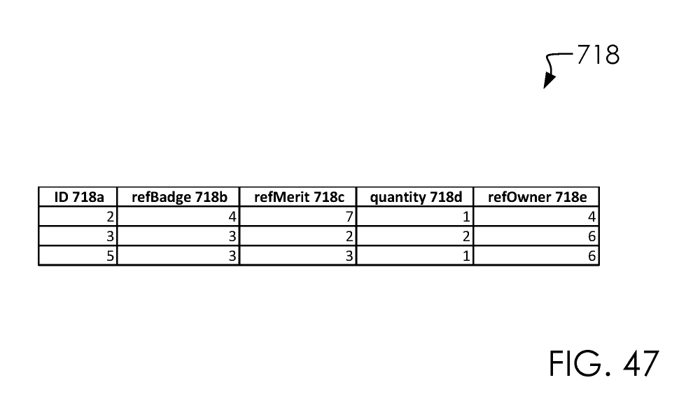

FIG. 47 illustrates data table view of a tblCRTmeritsInBadges 718.

In one embodiment, said tblCRTmeritsInBadges 718 can comprise a formula for earning badges. Said ID 718a can comprise a unique identifier; said refBadge 718b can comprise a badge reference; said refmerit 718c can comprise a merit required; said quantity 718d can comprise a quantity of merits necessary; and said tblCRTmeritsInBadges 718 can comprise an owner of the current formula.

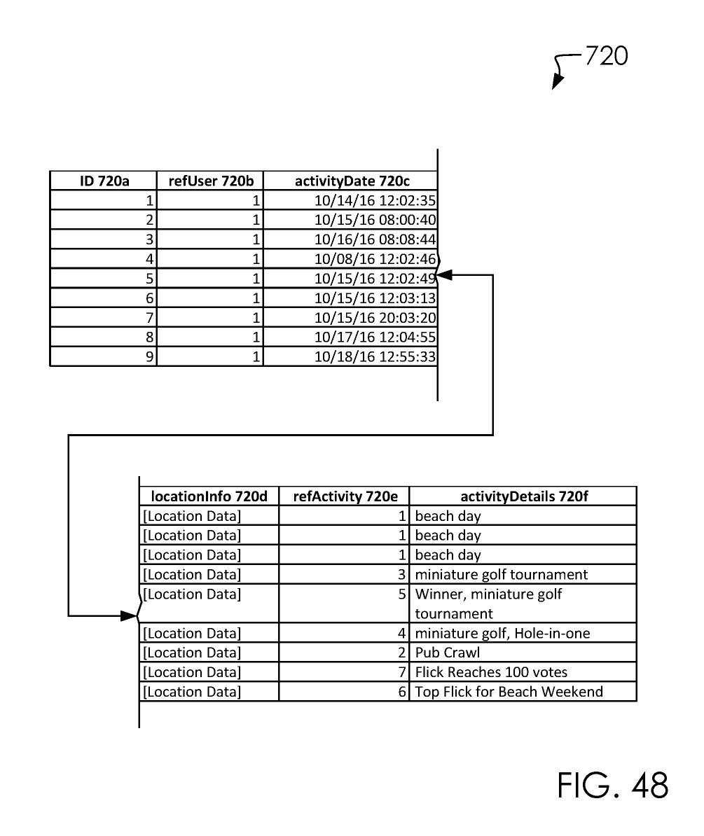

FIG. 48 illustrates data table view of a tblUserActivities 720.

In one embodiment, said tblUserActivities 720 can comprise a list of activities by each and every user of said software system 101. In one embodiment, said ID 720a can comprise a unique identifier; said activityDate 720b can comprise a reference to a user from said tblUsers 702; said locationInfo 720c can comprise a date of an activity; said activityDetails 720d can comprise a location for an activity; said refActivity 720e can comprise a reference to an activity from a list (where applicable, but not required); and said 720f/can comprise a summary of the activity.

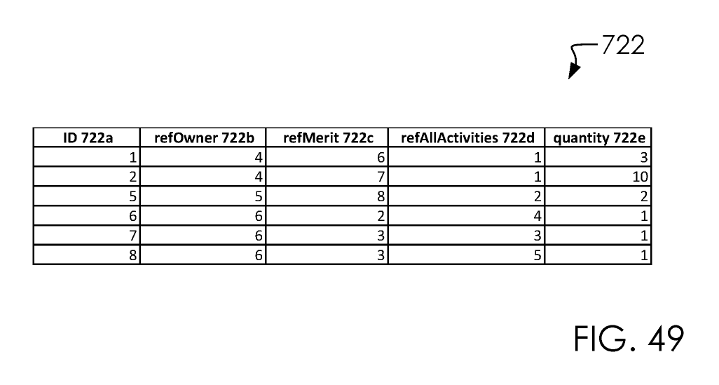

FIG. 49 illustrates data table view of a tblCRTActivitiesInmerits 722.

In one embodiment, said tblCRTActivitiesInmerits 722 a list of all activities necessary for earning a merit. In one embodiment, said ID 722a can comprise a unique identifier; said refOwner 722b can comprise a user reference from said tblUsers 702; said tblCRTActivitiesInmerits 722 can comprise a reference to a merit; said refAllActivities 722d can comprise an activity required along with an quantity (said quantity 722e) for earning the same.

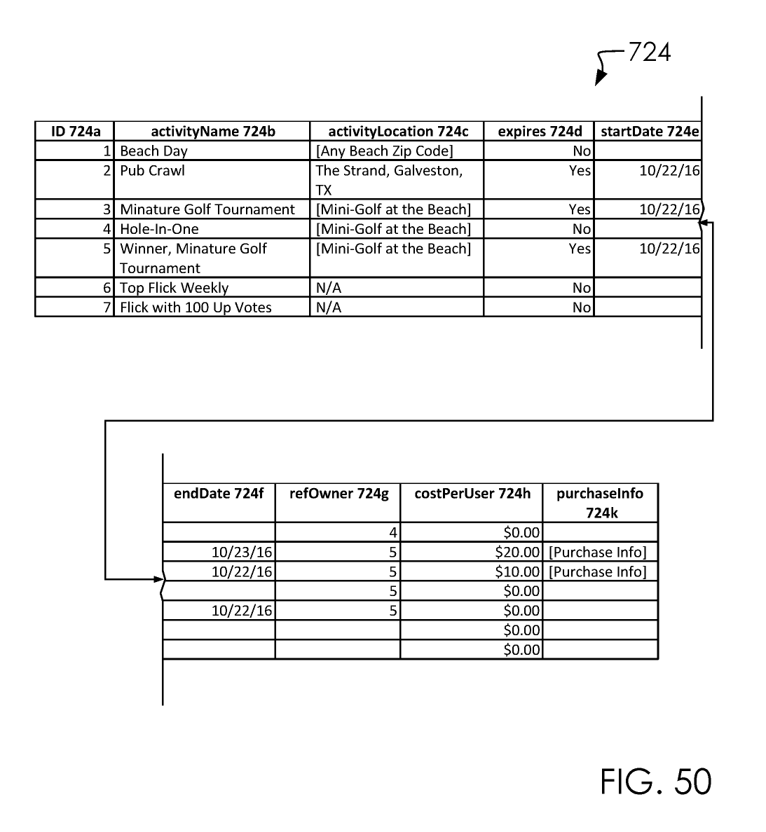

FIG. 50 illustrates data table view of a tblAllActivities 724.

Said tblAllActivities 724 can comprise a list of activities and various information related thereto.

Said ID 724a can comprise a unique identifier; said activityName 724b can comprise a name for the activity; said activityLocation 724c can comprise a one or more geography related fields such as a location for an activity; said expires 724d can comprise a flag for whether an activity will expire; said 724e and said endDate 724f can comprise dates for a start and end to an activity; said refOwner 724g can comprise a reference to a user in said 702 being the owner of an activity; said tblAllActivities 724 can comprise a cost for participating in an activity; and said 724k can comprise a one or more data fields related to purchasing an entry into an activity.

In one embodiment, said tblAllActivities 724 can comprise a list of past activities or future activities for which admission can be sold.

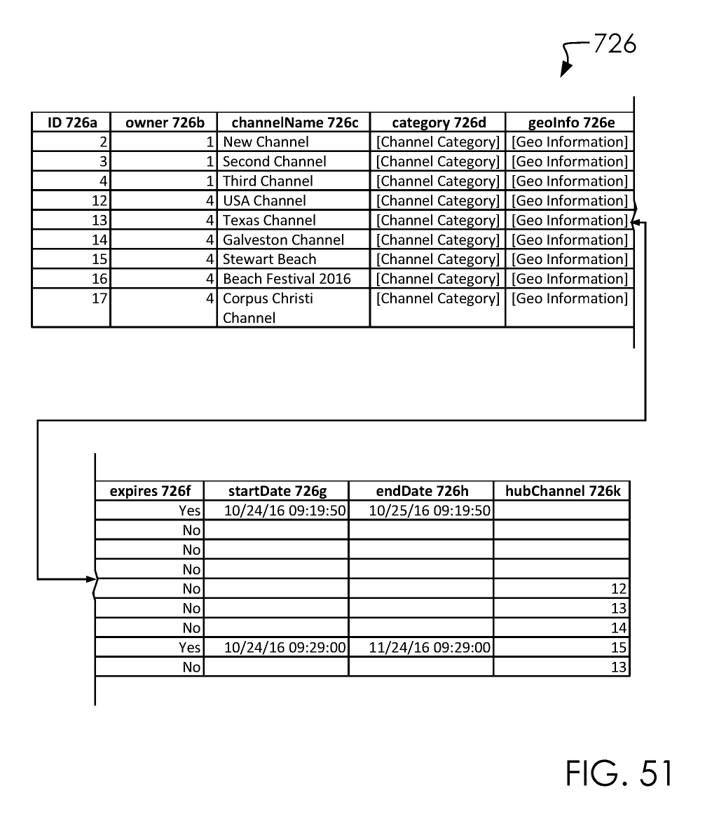

FIG. 51 illustrates data table view of a tblChannels 726.

In one embodiment, said tblChannels 726 can comprise a list of channels.

Said ID 726a can comprise a unique identifier; said owner 726b can comprise a reference to said tblUsers 702; said channelName 726c can comprise a name for a channel; said category 726d can comprise a category; said geoInfo 726e can comprise a geography reference; said expires 726f can comprise a flag for whether a channel will expire; said startDate 726g and said endDate 726h can comprise dates for the start and finish for a channel; and said hubChannel 726k can comprise a reference to another field in said tblChannels 726 which comprises a parent/master field in relationship to a current record, as is known in the art.

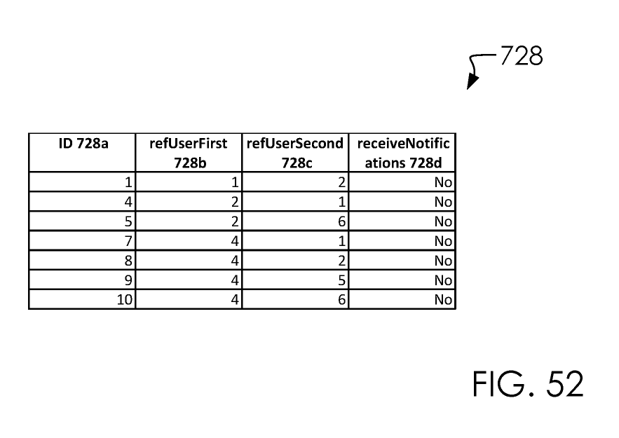

FIG. 52 illustrates data table view of a tblCRTUserConnections 728.

In one embodiment, said tblCRTUserConnections 728 can comprise a list of users related to one another, as is known in the art.

Said ID 728a can comprise a unique identifier; said refUserFirst 728b can comprise a reference to a first record in said tblUsers 702 and said refUserSecond 728c can comprise a reference to another reference in said tblUsers 702; and said receiveNotifications 728d can comprise a flag for whether said refUserFirst 728b wants information about said refUserSecond 728c to be sent to him directly, as is known in the art.

In one embodiment, additional fields may be used to manage other details of such a relationship such as romantic status, family connections, dates met, shared causes, shared schools, shared social events, etc., as is known in the art. For purposes of this disclosure, it is important to note that users may have relationships with one another and that those relationships determine the behavior of said device application 502.

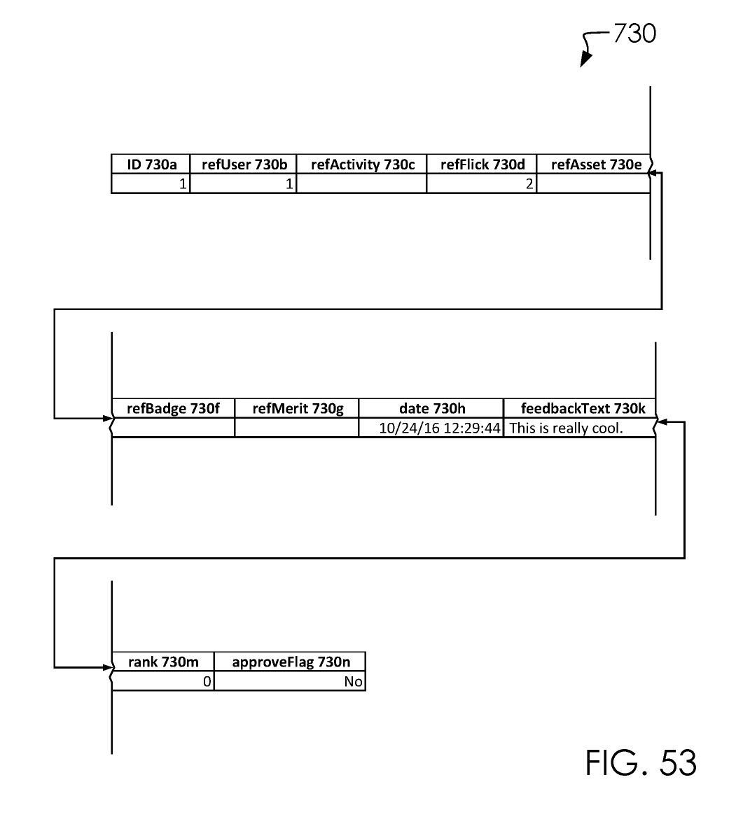

FIG. 53 illustrates data table view of a tblFeedback 730.

Said tblFeedback 730 can comprise a table for managing feedback within said software system 101.

Said ID 730a can comprise a unique identifier; said refUser 730b can comprise a reference to a field in said tblUsers 702; fields 730c-730g can comprise references to fields as indicated in the field names; said date 730h can comprise a date flag; said feedbackText 730k can comprise a text to accompany feedback; said rank 730m can comprise a rank associated with a feedback; and said approveFlag 730n can comprise a flag for indicating objectionable content.

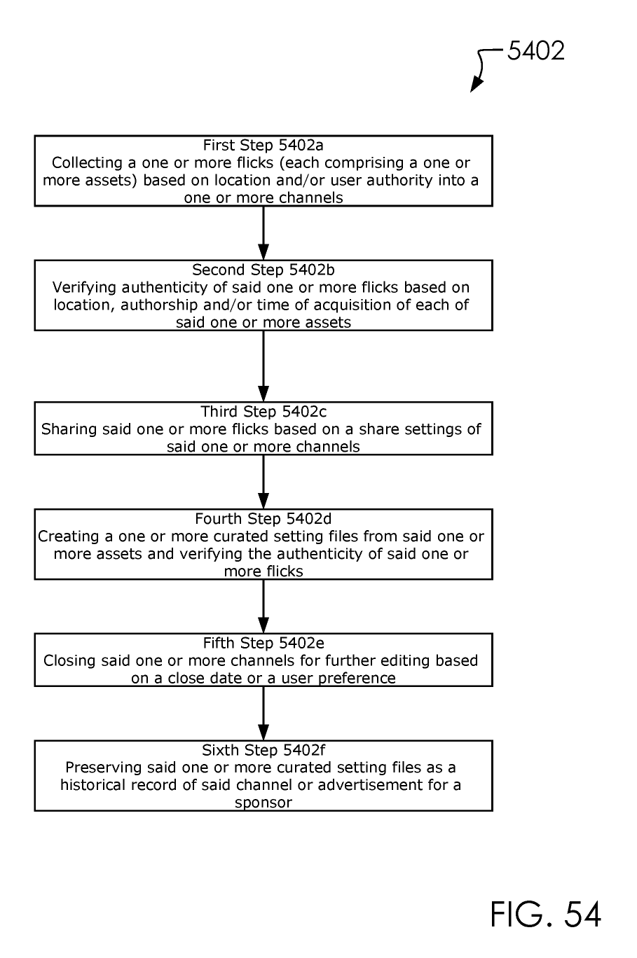

FIG. 54 illustrates a flow chart view of a software system use method 5402.

In one embodiment, said software system use method 5402 can comprise said collecting composite assets step 5402a, said verification of assets step 5402b, said sharing step 5402c, said creating a curated setting files step 5402d, said closing a channels step 5402e and said preserving said curated setting files step 5402f.

In one embodiment, said method of using system 5402 can comprise said first step 5402a, said second step 5402b, said third step 5402c, said fourth step 5402d, said fifth step 5402e, said sixth step 5402f.

In one embodiment, said first step 5402a can comprise collecting a one or more event flicks (each comprising a one or more fresh assets) based on location and user authority into a one or more channels; said second step 5402b can comprise verifying authenticity of said one or more event flicks based on location, authorship and-or time of acquisition of each of said one or more fresh assets said one or more event flicks comprise; said third step 5402c can comprise sharing said one or more event flicks based on a share settings of said one or more channels; said fourth step 5402d can comprise creating a one or more curated setting files from said one or more fresh assets and verifying the authenticity of said one or more curated setting files; said fifth step 5402e can comprise closing said one or more channels for further editing based on a close date or a user preference; and said sixth step 5402f can comprise preserving said one or more event flicks as a historical record of said channel.

In one embodiment, said curated setting files can be made in real time by an interested party, a third party interested in participating in a contest or remuneration, or by a sponsor directly. Said curated setting files can be promoted by a sponsor for good will, sales, or other commercial or non-commercial interests, as is known in the art.

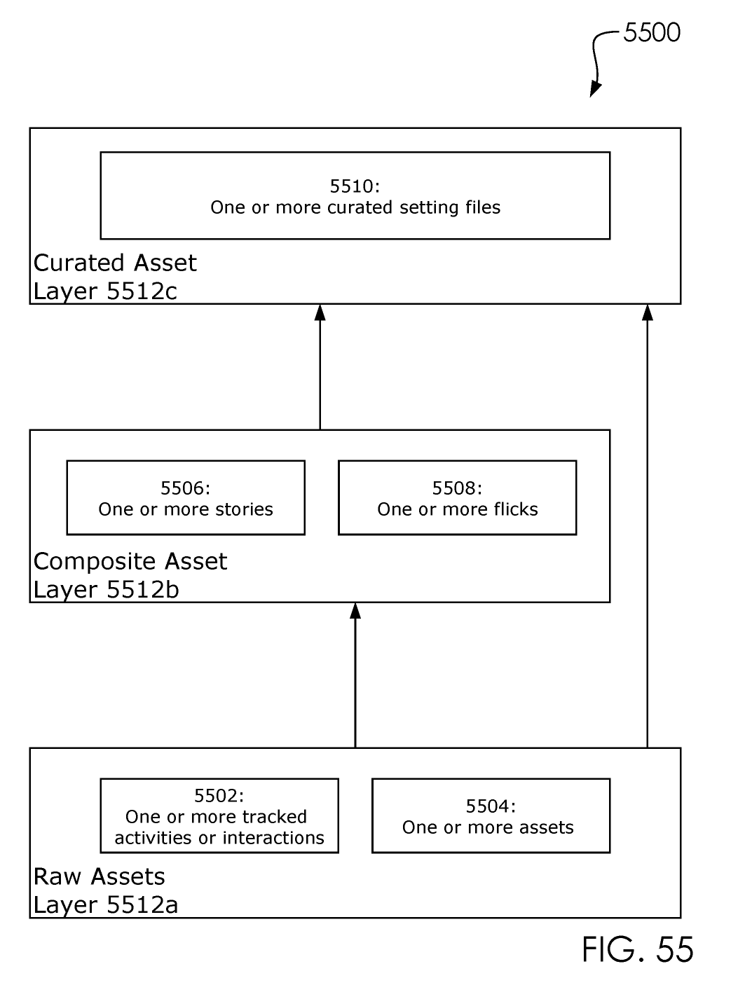

FIG. 55 illustrates a flow chart view of an asset progression chart 5500.

In one embodiment, said asset progression chart 5500 can comprise said one or more tracked activities or interactions 5502, said one or more assets 5504, said one or more stories 5506, said one or more flicks 5508, said one or more curated setting files 5510 and said one or more asset layers 5512.

In one embodiment, said one or more assets 5504 can comprise said one or more images 5504a, said one or more videos 5504b, said one or more audio files 5504c, said one or more notes 5504d, said one or more virtual reality files 5504e and said one or more augmented reality files 5504f.

In one embodiment, said one or more asset layers 5512 can comprise said raw asset layer 5512a, said composite asset layer 5512b and said curated asset layer 5512c.

In one embodiment, said raw asset layer 5512a can comprise said one or more tracked activities or interactions 5502 and said one or more assets 5504.

In one embodiment, said composite asset layer 5512b can comprise said one or more stories 5506 and said one or more flicks 5508.

In one embodiment, said curated asset layer 5512c can comprise said one or more curated setting files 5510.

The following sentences are included for completeness of this disclosure with reference to the claims.

A software system is disclosed. A one or more computers comprises a processor, a memory and a communication hardware. Said memory comprises said software system. Said software system comprises a device application and a database tables. Said database tables comprises a one or more tracked activities or interactions, a one or more assets, a one or more stories, a one or more flicks and a one or more curated setting files are configured to track a list of users, a list of assets, a list of composite assets, and a list of curated settings files. Said database tables are configured to track a list of users. Said software system comprises a raw asset layer, a composite asset layer and a curated asset layer. Said raw asset layer comprises said one or more tracked activities or interactions and said one or more assets. Said composite asset layer comprises said one or more stories and said one or more flicks. Said curated asset layer comprises said one or more curated setting files. Said one or more tracked activities or interactions comprise a list of activities of a one or more users being tracked in said list of users in said database tables. Said one or more assets comprise a plurality of digital asssets selected among a one or more images, a one or more videos, a one or more virtual reality files, or a one or more augmented reality files. Said one or more stories comprise a portion of said one or more raw asset layer being packaged up together. Said one or more flicks comprise a portion of said one or more raw asset layer being packaged up together. Said one or more curated setting files a portion of said composite asset layer being selected and combined to create a curated composite asset having economic value to at least one end user. A channels comprise collections of said raw asset layer, said composite asset layer, and said curated asset layer being grouped together on a similar theme and shared to a portion of said one or more users of said software system.

A software system is disclosed. A one or more computers comprises a processor, a memory and a communication hardware. Said memory comprises said software system. Said software system comprises a device application and a database tables. Said database tables comprises a one or more tracked activities or interactions, a one or more assets, a one or more stories, a one or more flicks and a one or more curated setting files. Said database tables are configured to track a list of users. Said software system comprises a raw asset layer, a composite asset layer and a curated asset layer. Said curated asset layer comprises said one or more curated setting files.

Said raw asset layer comprises said one or more tracked activities or interactions and said one or more assets.

Said one or more tracked activities or interactions comprise a list of activities of a one or more users being tracked in said list of users in said database tables.

Said one or more assets comprise a plurality of digital files for sharing and posting on said software system. Said one or more assets comprises a one or more images, a one or more videos, a one or more audio files, a one or more notes, a one or more virtual reality files and a one or more augmented reality files.

Said one or more stories a real-time shared asset where other users know that the location and time of sharing are real-time or recent.

Said one or more flicks shared groups of one or more assets having a one or more authors.

Said one or more curated setting files a portion of said composite asset layer being selected and combined to create a curated composite asset having economic value to at least one end user.

A channels comprise collections of said raw asset layer, said composite asset layer, and said curated asset layer being grouped together on a similar theme and shared to a portion of said one or more users of said software system.

Said composite asset layer comprises said one or more stories and said one or more flicks. Said composite asset layer wherein the term composite means the combination of a plurality of said one or more assets to form one new creative work.

A software system is disclosed. A one or more computers comprises a processor, a memory and a communication hardware. Said memory comprises said software system. Said software system comprises a device application and a database tables. Said software system comprises a raw asset layer and a composite asset layer. Said database tables are configured to track a list of users. Said composite asset layer comprises a one or more fresh assets. Said one or more fresh assets comprise a creation date being less than a threshold period from the current date.

Said one or more curated setting files comprise a one or more settings such as lock, unlock, and expiration.

Said one or more tracked activities or interactions are tracked manually by user input or automatically by monitoring a status of a computer associated with a portion of said one or more users.

Said one or more augmented reality files comprises a one or more layers. Said one or more layers comprises a visible layer and a virtual object layer. Said visible layer comprises a representation of the real world. Said virtual object layer comprises a one or more virtual objects superimpossed on said visible layer.

Said channels comprises said one or more stories and said one or more flicks. Said channels having said similar theme comprise one or more selected among geographic similarity, postal code, celebrations, events, or common interests.

Said software system combine portions of said raw asset layer, said composite asset layer and said curated asset layer to create a stream of assets for sharing with viewers of said channel wherein, said channel functions like a television network for entertainment and educational purposes.

Said one or more fresh assets wherein, said threshold period is seven days or less.

A software system use method is disclosed. Said software system use method comprises a collecting composite assets step, a creating a curated setting files step and a preserving said curated setting files step. Said software system use method comprises a software system, a one or more computers and a network. Said one or more computers comprises a one or more input devices, an address space, a processor, a memory, a communication hardware and a device application. Said software system processes said software system use method. Said software system comprises a raw asset layer and a composite asset layer. Said collecting composite assets step identifying a portion of said composite asset layer based on location or user authority. Said raw asset layer comprises a one or more tracked activities or interactions and a one or more assets. Said composite asset layer a one or more from among said raw asset layer. A curated asset layer a one or more from among said composite asset layer. Said creating a curated setting files step combining a one or more from among said composite asset layer into a one or more one or more curated setting files. Said preserving said curated setting files step comprises saving said one or more curated setting files according to a settings.

Said software system use method comprises said collecting composite assets step, a verification of assets step, a sharing step, said creating a curated setting files step and said preserving said curated setting files step. Said verification of assets step verifying the authenticity of a time, place, or group of users for each among said raw asset layer. Said sharing step sharing said curated asset layer on said software system.

Said software system use method comprises said collecting composite assets step, said creating a curated setting files step, a closing a channels step and said preserving said curated setting files step. Said closing a channels step comprises closing an asset for further editing according to a schedule, event, or whim of the owner thereof.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A software system, wherein:
a one or more computers comprises a processor, a memory and a communication hardware;
said memory comprises said software system;
said software system comprises a device application and a database tables;
said database tables comprises a one or more tracked activities or interactions, a one or more assets, a one or more stories, a one or more flicks and a one or more curated setting files are configured to track a list of users, a list of assets, a list of composite assets, and a list of curated settings files;
said database tables are configured to track a list of users;
said software system comprises a raw asset layer, a composite asset layer and a curated asset layer;
said raw asset layer comprises said one or more tracked activities or interactions and said one or more assets;
said composite asset layer comprises said one or more stories and said one or more flicks;
said curated asset layer comprises said one or more curated setting files;
said one or more tracked activities or interactions comprise a list of activities of a one or more users being tracked in said list of users in said database tables;
said one or more assets comprise a plurality of digital asssets selected among a one or more images, a one or more videos, a one or more virtual reality files, or a one or more augmented reality files;
said one or more stories comprise a portion of said one or more raw asset layer being packaged up together;
said one or more flicks comprise a portion of said one or more raw asset layer being packaged up together;
said one or more curated setting files a portion of said composite asset layer being selected and combined to create a curated composite asset having economic value to at least one end user; and
a channels comprise collections of said raw asset layer, said composite asset layer, and said curated asset layer being grouped together on a similar theme and shared to a portion of said one or more users of said software system.

2. A software system, wherein:
a one or more computers comprises a processor, a memory and a communication hardware;
said memory comprises said software system;
said software system comprises a device application and a database tables;
said database tables comprises a one or more tracked activities or interactions, a one or more assets, a one or more stories, a one or more flicks and a one or more curated setting files;
said database tables are configured to track a list of users;
said software system comprises a raw asset layer, a composite asset layer and a curated asset layer; and
said curated asset layer comprises said one or more curated setting files.

3. The software system of claim 2 wherein:
said raw asset layer comprises said one or more tracked activities or interactions and said one or more assets.

4. The software system of claim 2 wherein:
said one or more tracked activities or interactions comprise a list of activities of a one or more users being tracked in said list of users in said database tables.

5. The software system of claim 2 wherein:
said one or more assets comprise a plurality of digital files for sharing and posting on said software system; and
said one or more assets comprises a one or more images, a one or more videos, a one or more audio files, a one or more notes, a one or more virtual reality files and a one or more augmented reality files.

6. The software system of claim 2 wherein:
said one or more stories a real-time shared asset where other users know that the location and time of sharing are real-time or recent.

7. The software system of claim 2 wherein:
said one or more flicks shared groups of one or more assets having a one or more authors.

8. The software system of claim 2 wherein:
said one or more curated setting files a portion of said composite asset layer being selected and combined to create a curated composite asset having economic value to at least one end user.

9. The software system of claim 2 wherein:
a channels comprise collections of said raw asset layer, said composite asset layer, and said curated asset layer being grouped together on a similar theme and shared to a portion of said one or more users of said software system.

10. The software system of claim 2 wherein:
said composite asset layer comprises said one or more stories and said one or more flicks; and
said composite asset layer wherein the term composite means the combination of a plurality of said one or more assets to form one new creative work.

11. A software system, wherein:
a one or more computers comprises a processor, a memory and a communication hardware;
said memory comprises said software system;
said software system comprises a device application and a database tables;
said software system comprises a raw asset layer and a composite asset layer;
said database tables are configured to track a list of users;
said composite asset layer comprises a one or more fresh assets; and
said one or more fresh assets comprise a creation date being less than a threshold period from the current date.

12. The software system of claim 2 wherein:
said one or more curated setting files comprise a one or more settings such as lock, unlock, and expiration.

13. The software system of claim 4 wherein:
said one or more tracked activities or interactions are tracked manually by user input or automatically by monitoring a status of a computer associated with a portion of said one or more users.

14. The software system of claim 6 wherein:
said one or more augmented reality files comprises a one or more layers;
said one or more layers comprises a visible layer and a virtual object layer;
said visible layer comprises a representation of the real world; and
said virtual object layer comprises a one or more virtual objects superimpossed on said visible layer.

15. The software system of claim 11 wherein:
said channels comprises said one or more stories and said one or more flicks; and
said channels having said similar theme comprise one or more selected among geographic similarity, postal code, celebrations, events, or common interests.

16. The software system of claim 11 wherein:
said software system combine portions of said raw asset layer, said composite asset layer and said curated asset layer to create a stream of assets for sharing with viewers of said channel wherein, said channel functions like a television network for entertainment and educational purposes.

17. The software system of claim 16 wherein:
said one or more fresh assets wherein, said threshold period is seven days or less.

18. A software system use method, wherein:
said software system use method comprises a collecting composite assets step, a creating a curated setting files step and a preserving said curated setting files step;
said software system use method comprises a software system, a one or more computers and a network;
said one or more computers comprises a one or more input devices, an address space, a processor, a memory, a communication hardware and a device application;
said software system processes said software system use method;
said software system comprises a raw asset layer and a composite asset layer;
said collecting composite assets step identifying a portion of said composite asset layer based on location or user authority;
said raw asset layer comprises a one or more tracked activities or interactions and a one or more assets;
said composite asset layer a one or more from among said raw asset layer;
a curated asset layer a one or more from among said composite asset layer;
said creating a curated setting files step combining a one or more from among said composite asset layer into a one or more one or more curated setting files; and
said preserving said curated setting files step comprises saving said one or more curated setting files according to a settings.

19. The software system use method of claim 18 wherein:
said software system use method comprises said collecting composite assets step, a verification of assets step, a sharing step, said creating a curated setting files step and said preserving said curated setting files step;
said verification of assets step verifying the authenticity of a time, place, or group of users for each among said raw asset layer; and
said sharing step sharing said curated asset layer on said software system.

20. The software system use method of claim 18 wherein:
said software system use method comprises said collecting composite assets step, said creating a curated setting files step, a closing a channels step and said preserving said curated setting files step; and
said closing a channels step comprises closing an asset for further editing according to a schedule, event, or whim of the owner thereof.
